(19) United States
(12) Patent Application Publication
(10) Pub. No.: US 2026/0312801 A1
(43) Pub. Date: Oct. 8, 2026

(54) Automatically Updating Cryptographic Keys Using a Learning Model

(71) Applicant: eBay Inc., San Jose, CA (US)

(72) Inventors: Weihua Wang, Shanghai (CN); Huayu Li, Shanghai (CN)

(73) Assignee: eBay Inc., San Jose, CA (US)

(21) Appl. No.: 19/170,341

(22) Filed: Apr. 4, 2025

(51) Int. Cl. H04L 9/08; H04L 9/32

(52) U.S. Cl. CPC H04L 9/0891; H04L 9/0825; H04L 9/32

(57) ABSTRACT

Automatically updating cryptographic keys using a learning model is described. A computing device receives a notification from another computing device to update at least one cryptographic key corresponding to a cryptographic key pair (e.g., a public cryptographic key and/or a private cryptographic key) associated with an exchange of data between the computing device and the other computing device. The notification includes first criterion associated with the cryptographic key. The computing device generates an updated cryptographic key by the second computing device based on providing the first criterion and second criterion associated with the cryptographic key as input to a learning model. The computing device exchanges the data between the first computing device and the second computing device based on the updated cryptographic key.

### BACKGROUND

Computing devices can implement various techniques to secure data exchanges between different systems. For example, public key infrastructure (PKI) enables secure communication by using a cryptographic key pair including a public cryptographic key and a private cryptographic key. Cryptographic keys may have various attributes, such as key length, algorithm type, a use for the cryptographic keys, and validity period. Key management systems perform key generation, distribution, storage, and renewal to maintain the secure communications over time.

The computing device may use machine learning and/or artificial intelligence techniques to generate information by analyzing patterns in data. The computing device can implement one or more learning models, such as artificial intelligence models and/or machine learning models, to capture patterns and relationships in the data, enabling the models to make predictions or decisions on new, unseen data.

### SUMMARY

A computing device receives a notification (e.g., a message, signaling) from another device, such as a device in a server system, to update a cryptographic key of a cryptographic key pair. The notification includes a criterion defined by the other device for the update to the cryptographic key, including, but not limited to, a length of the cryptographic key, a validity period of the cryptographic key, an algorithm used to generate the cryptographic key, a use for the cryptographic key, or a format of the cryptographic key. The computing device generates an updated cryptographic key using a learning model. The computing device can generate the updated cryptographic key, such that the updated cryptographic key satisfies the criterion defined by the other device and a criterion defined by the computing device. The computing devices exchange data with the other device using the updated key.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIGS. 1 and 2 are illustrations of an environment in an example implementation that is operable to employ techniques described herein.

FIGS. 3 and 4 depict example procedures for automatically updating cryptographic keys using a learning model.

FIGS. 5 through 8 depict example architectures for automatically updating cryptographic keys using a learning model.

FIG. 9 depicts an example timeline for automatically updating cryptographic keys using a learning model.

FIGS. 10 through 14 depict procedures in example implementations of automatically updating cryptographic keys using a learning model.

FIG. 15 illustrates an example of a system that includes an example computing device that is representative of one or more computing systems and/or devices that may implement the various techniques described herein.

### DETAILED DESCRIPTION

### Overview

Techniques for automatically updating cryptographic keys using a learning model are described. A computing device receives a notification from another computing device, referred to as a partner computing device, to update one or more cryptographic keys of a cryptographic key pair, including a public cryptographic key for the computing device and/or a corresponding private cryptographic key of the computing device. The computing device generates the updated or new cryptographic keys by providing criterion for the updated cryptographic keys from both computing devices as input to a learning model. The computing device and the partner computing device may use the updated cryptographic keys of the cryptographic key pair to securely exchange data.

Conventional techniques for managing cryptographic keys (e.g., by PKI systems) may rely on manual processes, including user input, to perform key generation, distribution, and renewal. For example, a user may receive a notification (e.g., a message) that a cryptographic key is expired. The user may manually analyze criterion for a new or updated cryptographic key to ensure the new or updated cryptographic key satisfies the criterion. However, a user manually analyzing criterion for to update a cryptographic key is time consuming, introducing latency into the cryptographic key management process, and may lead to errors due to the user incorrectly interpreting the criterion. Further, the cryptographic keys may be used at many different devices in a distributed system, such that a user may be unable to manually generate the updated cryptographic keys prior to the cryptographic keys expiring. If a user is unable to manually generate the updated cryptographic keys prior to the cryptographic keys expiring, then the security of any data exchange using the expired cryptographic keys may be compromised and/or the data exchange may be paused, leading to service interruptions.

Conventional techniques for managing cryptographic keys may be unable to adapt to evolving security criterion for different services and external partners. Thus, conventional cryptographic key generation may not account for variations in key attributes, including algorithm type, key length, or validity periods across different services, systems, and use cases. The inflexibility can result in either overly permissive security policies that introduce security vulnerabilities or overly restrictive policies that reduce interoperability and operational efficiency.

As described herein, to reduce inefficiencies related to conventional techniques for managing cryptographic keys, as well as to improve data security for an exchange of data using the cryptographic keys, a computing device and/or server system can implement one or more learning models to analyze criterion and generate one or more updated cryptographic keys, accordingly. The computing device can receive a notification from a partner computing device and/or from the server system that a cryptographic key at the partner computing device is within a threshold duration from expiring. The computing device may initiate generation of one or more updated or new cryptographic keys in response to receiving the notification (e.g., a public cryptographic key and/or a private cryptographic key at the computing device). Respective devices (e.g., the computing device and the partner computing device) may generate a public cryptographic key for distribution to other devices and a private cryptographic key that is for implementation at the respective devices, such that the private cryptographic keys are not accessible by other devices.

The computing device and/or the server system collect (e.g., receive, obtain, access) criterion for the updated cryptographic keys from the computing device and from the partner computing device. The criterion can indicate attributes of the cryptographic keys, including, but not limited to, a length of the cryptographic keys, an algorithm used to generate the cryptographic keys, a validity period for the cryptographic keys, a use for the cryptographic keys, or a format of the cryptographic keys. For example, the computing device may provide services by exchanging data using cryptographic keys with multiple computing devices (e.g., partner endpoints) that operate according to different security levels, defined by the criterion. The computing device can use a learning model to generate updated cryptographic keys that satisfy the criterion (e.g., the security levels) of the computing device and the partner computing device and can use the updated cryptographic keys to exchange data.

By utilizing a learning model to generate the updated cryptographic keys, a computing device and/or a server system can analyze multiple sets of criterion for exchange of data between computing devices, generate cryptographic keys that satisfy the criterion and a corresponding security level for the computing devices, and manage key rotation processes with minimal disruption to data flow between the computing devices. That is, the computing device and/or the server system implement the learning model to automate cryptographic key generation, distribution, activation, and renewal, while ensuring compliance with diverse security policies across different computing devices. Automating cryptographic key generation reduces latency and errors related to manual cryptographic key generation without compromising security or interoperability.

In some aspects, the techniques described herein relate to a computer-implemented method including receiving, from a first computing device, a notification to update a cryptographic key corresponding to a cryptographic key pair (e.g., at least one of a public cryptographic key or a private cryptographic key of the cryptographic key pair) associated with an exchange of data between the first computing device and a second computing device, where the notification includes first criterion (e.g., security policies) associated with the cryptographic key, generating, by the second computing device based on providing the first criterion and second criterion associated with the cryptographic key as input to a learning model (e.g., machine learning model, artificial intelligence model), an updated cryptographic key, and exchanging, between the first computing device and the second computing device, the data based on the updated cryptographic key.

In some aspects, the techniques described herein relate to a computer-implemented method, further including obtaining (e.g., receiving), as output from the learning model, metadata associated with the updated cryptographic key, outputting the metadata for display at a user interface associated with the second computing device, and receiving, via the user interface, feedback that indicates at least one of acceptance of the metadata or rejection of the metadata, where generating the updated cryptographic key is based on the acceptance of the metadata or the rejection of the metadata.

In some aspects, the techniques described herein relate to a computer-implemented method, further including transmitting, to the first computing device, the updated cryptographic key, where the updated cryptographic key includes a public cryptographic key of the cryptographic key pair, and receiving, from the first computing device, at least one acknowledgement message associated with the updated cryptographic key, where exchanging the data is based on the at least one acknowledgement message.

In some aspects, the techniques described herein relate to a computer-implemented method, further including selecting, by the second computing device and based on another cryptographic key corresponding to the cryptographic key pair, at least one of the updated cryptographic key or the cryptographic key to use for one or more of encrypting, signing, or decrypting the data for a time period after generating the updated cryptographic key.

In some aspects, the techniques described herein relate to a computer-implemented method, where exchanging the data includes encrypting, at the second computing device, the data using a public cryptographic key associated with the first computing device, signing, at the second computing device, the data using a private cryptographic key of the cryptographic key pair (e.g., a private cryptographic key of the second computing device), where the updated cryptographic key includes the private cryptographic key, and transmitting the data to the first computing device.

In some aspects, the techniques described herein relate to a computer-implemented method, where exchanging the data includes receiving, at the second computing device, the data, where the data is encrypted based on a public cryptographic key of the cryptographic key pair (e.g., a public cryptographic key of the second computing device), where the public cryptographic key includes the cryptographic key or the updated cryptographic key, decrypting the data using a private cryptographic key associated with the second computing device, and verifying, at the second computing device, the data using a public cryptographic key associated with the first computing device.

In some aspects, the techniques described herein relate to a computer-implemented method, where the first criterion and the second criterion includes one or more of a length associated with the cryptographic key, an algorithm associated with the cryptographic key, a validity period associated with the cryptographic key, a use associated with the cryptographic key, or a format associated with the cryptographic key.

In some aspects, the techniques described herein relate to a computer-implemented method, where the updated cryptographic key satisfies the first criterion and satisfies the second criterion.

In some aspects, the techniques described herein relate to a computer-implemented method, further including obtaining, at the second computing device, input that indicates the second criterion, where the first criterion is independent of the second criterion, and storing the second criterion at a local data storage of the second computing device, where the second criterion is accessible for generating the updated cryptographic key.

In some aspects, the techniques described herein relate to a system including one or more processors, and a computer-readable storage medium storing instructions that are executable by the one or more processors to perform operations including receiving, from a first computing device, a notification to update a cryptographic key corresponding to a cryptographic key pair associated with an exchange of data between the first computing device and a second computing device, where the notification includes first criterion associated with the cryptographic key, generating, by the second computing device based on providing the first criterion and second criterion associated with the cryptographic key as input to a learning model, an updated cryptographic key, and exchanging, between the first computing device and the second computing device, the data based on the updated cryptographic key.

In some aspects, the techniques described herein relate to a system, where the operations further include obtaining, as output from the learning model, metadata associated with the updated cryptographic key, outputting the metadata for display at a user interface associated with the second computing device, and receiving, via the user interface, feedback that indicates at least one of acceptance of the metadata or rejection of the metadata, where generating the updated cryptographic key is based on the acceptance of the metadata or the rejection of the metadata.

In some aspects, the techniques described herein relate to a system, where the operations further include transmitting, to the first computing device, the updated cryptographic key, where the updated cryptographic key includes a public cryptographic key of the cryptographic key pair, and receiving, from the first computing device, at least one acknowledgement message associated with the updated cryptographic key, where exchanging the data is based on the at least one acknowledgement message.

In some aspects, the techniques described herein relate to a system, where the operations further include selecting, by the second computing device and based on another cryptographic key corresponding to the cryptographic key pair, at least one of the updated cryptographic key or the cryptographic key to use for at least one of signing, encrypting, or decrypting the data for a time period after generating the updated cryptographic key.

In some aspects, the techniques described herein relate to a computer-implemented method including transmitting, to a first computing device, a notification to update a cryptographic key corresponding to a cryptographic key pair associated with an exchange of data between the first computing device and a second computing device, where the notification includes first criterion associated with the cryptographic key, receiving, from the first computing device and based on the first criterion and second criterion associated with the cryptographic key, an updated cryptographic key, where the updated cryptographic key is output from a learning model, and exchanging, between the first computing device and the second computing device, the data based on the updated cryptographic key.

In some aspects, the techniques described herein relate to a computer-implemented method, further including transmitting, to the first computing device, at least one acknowledgement message associated with the updated cryptographic key, where exchanging the data is based on the at least one acknowledgement message.

In some aspects, the techniques described herein relate to a computer-implemented method, further including selecting, by the second computing device and based on another cryptographic key corresponding to the cryptographic key pair, at least one of the updated cryptographic key or the cryptographic key to use for one or more of encrypting, signing, or decrypting the data for a time period after generating the updated cryptographic key.

In some aspects, the techniques described herein relate to a computer-implemented method, where exchanging the data includes encrypting, at the second computing device, the data using a public cryptographic key of the cryptographic key pair, where the updated cryptographic key includes the public cryptographic key, signing, at the second computing device, a private cryptographic key associated with the second computing device, and transmitting the data to the first computing device.

In some aspects, the techniques described herein relate to a computer-implemented method, where exchanging the data includes receiving, at the second computing device, the data, where the data is encrypted based on a public cryptographic key associated with the second computing device, decrypting the data using a private cryptographic key associated with the second computing device, and verifying, at the second computing device, the data using a public cryptographic key associated with the first computing device, where the updated cryptographic key includes the public cryptographic key associated with the first computing device.

In some aspects, the techniques described herein relate to a computer-implemented method, where the first criterion and the second criterion includes one or more of a length associated with the cryptographic key, an algorithm associated with the cryptographic key, a validity period associated with the cryptographic key, a use associated with the cryptographic key, or a format associated with the cryptographic key, and where the updated cryptographic key satisfies the first criterion and satisfies the second criterion.

In some aspects, the techniques described herein relate to a computer-implemented method, further including obtaining, at the second computing device, input that indicates the second criterion, where the first criterion is independent of the second criterion, and storing the second criterion at a local data storage of the second computing device, where the second criterion is accessible for generating the updated cryptographic key.

### Example of an Environment

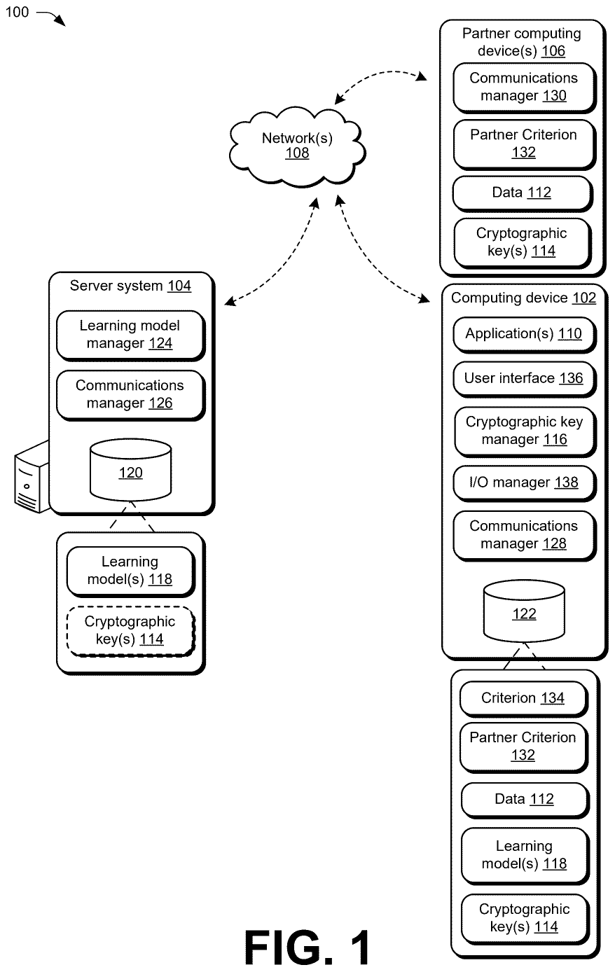

FIG. 1 is an illustration of an environment 100 in an example implementation that is operable to implement techniques described herein. The environment 100 includes a computing device 102, a server system 104, and one or more partner computing devices 106. In one or more implementations, the computing device 102, the partner computing devices 106, and the server system 104 may be communicatively coupled via one or more networks 108. An example of the networks 108 is the Internet, although the computing device 102, the server system 104, and the partner computing devices 106 may be communicatively coupled using one or more different connections or different networks 108 (e.g., wireless networks, cellular networks) in various implementations.

A server system 104 may include one or more devices, such as application servers, database servers, web servers, and file servers, among other examples, to manage different aspects of data processing and storage. The devices in the server system 104 may be referred to as server devices. In some examples, the computing device 102, the partner computing devices 106, and the server devices in the server system 104 may exchange instructions, signaling, messages, or other communications via the networks 108 (e.g., a wireless connection, over the air) or via a wired connection (e.g., a physical connections). For example, the server devices may transmit signaling to the computing device 102 and/or the partner computing devices 106 that includes instructions that cause the computing device 102 and/or the partner computing devices 106 to perform one or more tasks or actions (display or output feedback or notifications, manage cryptographic keys, transmit signaling, etc.). The computing device 102 and/or the partner computing devices 106 may receive and decode the signaling and may perform the actions according to the instructions.

Although the server system 104 is depicted in the environment 100 as being separate from the computing device 102 and/or the partner computing devices 106, in one or more implementations, an entirety, or various portions of the server system 104 may be implemented at or by the computing device 102 and/or the partner computing devices 106. In at least one implementation, for example, at least a portion of the server system 104 may be implemented by an application 110 of the computing device 102 and/or using various resources of the computing device 102, such as hardware resources, an operating system, firmware, and so forth. Additionally, or alternatively, the server system 104 may be implemented by server-based storage resources, processing resources, and so on of devices other than the computing device 102 and/or the partner computing devices 106. For example, at least a portion of the server system 104 may be implemented using a third-party service, such as a web services platform that provides one or more hardware and/or other computing resources to support provision of services by web service providers. In variations, an entirety, or various portions of the server system 104 may be implemented at or by a device of the user (e.g., a mobile device, a laptop, a wearable device, or any other device).

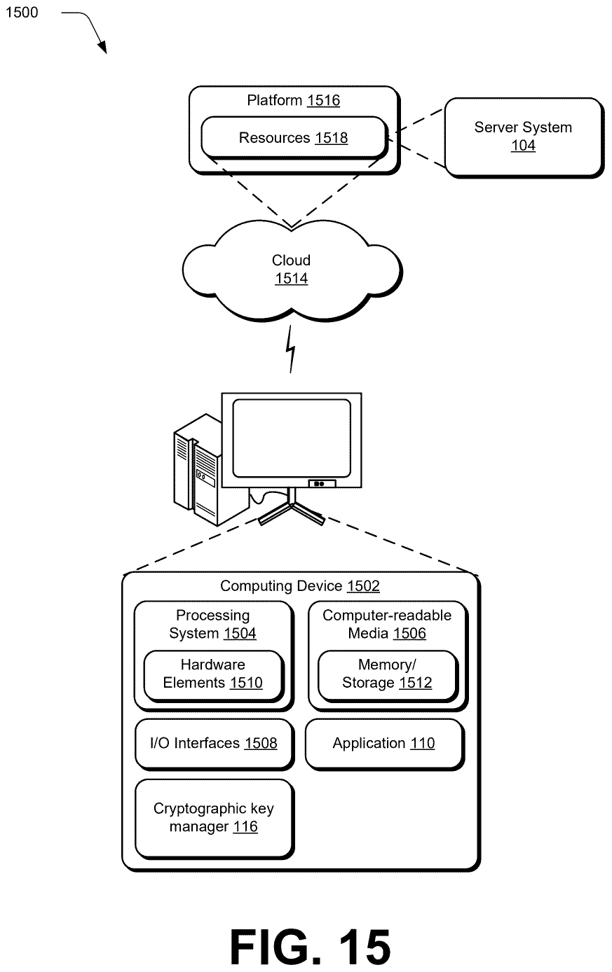

A computing device 102 and/or partner computing devices 106 that implement the environment 100 are configurable in a variety of ways. A computing device 102 and/or a partner computing device 106, for example, may be configurable as a desktop computer, a laptop computer, a mobile device (e.g., assuming a handheld configuration such as a tablet or mobile phone), an internet of things (IoT) device, a wearable device (e.g., a smart watch, a ring, or smart glasses), an augmented reality and/or virtual reality device (e.g., the smart glasses), a server, and so forth. Thus, a computing device 102 and/or a partner computing device 106 may range from full resource devices with substantial memory and processor resources to low-resource devices with limited memory and/or processing resources. Although in instances in the following discussion reference is made to a computing device 102 and/or a partner computing devices 106 in the singular, a computing device 102 and/or a partner computing device 106 may also be representative of multiple different devices, such as multiple servers of a server farm utilized to perform operations “over the cloud” as further described in relation to FIG. 15.

The partner computing devices 106 may provide one or more services to the computing device 102 and/or the server system 104. In some examples, the computing device 102 and/or the server system 104 may implement or deploy an application 110 that facilitates the exchange of goods or services via the application 110 (e.g., an online marketplace application). As part of the exchange of goods or services, the computing device 102 and/or the server system 104 can request for the partner computing device 106 to perform a data transaction. For example, the partner computing device 106, which may also be referred to as a partner endpoint, can implement payment services for the exchange of goods or services at the application 110 on the computing device 102. In some examples, the partner computing device 106 may include one or more server devices in addition to, or as an alternative to, computing devices.

In at least one implementation, the application 110 may support communication of data 112 across the networks 108 between the computing device 102 and the partner computing devices 106. In at least one other implementation, the application 110 may support communication additional data across the networks 108 between the computing device 102, the partner computing device 106, and the server system 104 (e.g., instructions to cause the computing device 102 and/or the partner computing device 106 to perform tasks or actions). One example of the application 110 is a browser or other web application that facilitates user interaction with cryptographic keys 114 for exchange of the data 112. Another example of the application 110 is a web-based computer application that facilitates user interaction with cryptographic keys 114 for exchange of the data 112, such as a mobile application or a desktop application. The application 110 may be configured in different ways, which provide for users to interact with the computing device 102 and by extension perform actions to view, create, or otherwise interact with cryptographic keys 114, without departing from the spirit or scope of the techniques described herein.

The application 110 may support (e.g., be capable of) implementing services from the partner computing devices 106 by use of one or more cryptographic keys 114 to secure the exchange of data between the computing device 102 implementing the application 110 and the partner computing devices 106. A cryptographic key 114 may include a digital code or strings of data used in cryptographic algorithms to encrypt (e.g., encode), sign, decrypt (e.g., decode), or authenticate information. In some examples, cryptographic keys 114 may be implemented as part of a PKI system, which may utilize asymmetric cryptography including cryptographic key pairs. Each cryptographic key pair may include a public cryptographic key that can be freely distributed and a corresponding private cryptographic key that is kept secret by an owner of the private cryptographic key.

The computing device 102 may encrypt the data 112 using a public cryptographic key of a partner computing device 106 before transmission. The computing device 102 may sign the data 112 using a private cryptographic key of the computing device 102. Upon receiving the encrypted data, the partner computing device 106 may then use a private cryptographic key of the partner computing device 106 to decrypt and access the data 112. The partner computing device 106 verifies the data 112 using a public cryptographic key of the computing device 102. Additionally, or alternatively, a partner computing device 106 may encrypt the data 112 using a public cryptographic key of the computing device 102 and may sign the data 112 using a private cryptographic key of the partner computing device 106. The computing device 102 decrypts the data 112 using a private cryptographic key of the computing device 102 and verifies an authenticity of the data 112 using a public cryptographic key of the partner computing device 106.

In some cases, the cryptographic keys 114 may be used to establish secure communication channels between devices. For example, the computing device 102 and one or more partner computing devices 106 may perform a key exchange protocol to generate, activate, and deploy the cryptographic keys 114, which can then be used to encrypt and decrypt data 112 transmitted between the computing device 102 and the one or more partner computing devices 106. A partner computing device 106 may present a digital certificate including a public cryptographic key to the computing device 102. The computing device 102 may verify a validity of the certificate and may use the public cryptographic key to authenticate an identity of the partner computing device 106 prior to initiating exchange of the data 112.

In some cases, the cryptographic keys 114 may have attributes, such as a key length, an algorithm type, a use case for the cryptographic keys 114, or a validity period. A key length refers to the size of the cryptographic key in bits, such as 128 bits, 256 bits, or 2048 bits. A cryptographic key 114 with a greater length provides stronger security (e.g., greater than a threshold security level), but may result in increased use of computational resources (e.g., memory, processing, and power resources) related to generating and processing the additional bits. An algorithm type indicates a cryptographic algorithm used to generate the cryptographic key 114 (e.g., an Rivest-Shamir-Adleman algorithm, advanced encryption standard algorithm, or an elliptic curve cryptography algorithm). Different cryptographic algorithms provide for different security properties and performance characteristics. A validity period defines a time period or duration during which a cryptographic key 114 is secure to use (e.g., authorized, valid). The validity period may be defined by a start of a time period (e.g., a date), an end of the time period, and/or a duration of the time period. After the validity period expires, then a computing device 102 may renew or replace the cryptographic key 114 to maintain security.

A use case for the cryptographic key 114 may include a parameter value that defines when and how the cryptographic key 114 is to be used by the computing device 102 and/or the partner computing device 106. For example, a value ALL, provides for the cryptographic key 114 to be used for all cryptographic operations, including encryption, decryption, signing, and verification. Additionally, or alternatively, a value ENC, provides for the cryptographic key 114 to be used for encryption operations. Additionally, or alternatively, a value DEC, provides for the cryptographic key 114 to be used for decryption of encrypted data. Additionally, or alternatively, a value SIGN, provides for the cryptographic key 114 to be used for creating digital signatures. Additionally, or alternatively, a value VERIFY, provides for the cryptographic key 114 to be used for verifying digital signatures. In some cases, a value of the parameter may indicate a combination of these usages, such as a value ENC_DEC, which provides for the cryptographic key 114 to be used for both encryption and decryption operations. Additionally, or alternatively, a value SIGN_VERIFY provides for the cryptographic key 114 to be used for both creating and verifying digital signatures. Additionally, or alternatively, a value ENC_SIGN provides for the cryptographic key 114 to be used for encryption and digital signature creation. The attributes may impact a security level and compatibility of the exchange of the data 112 between the computing device 102 and partner computing devices 106.

Conventional techniques for cryptographic key generation include manual processes that introduce inefficiencies and security vulnerabilities. The manual processes lead to errors, delays, and inconsistencies in cryptographic key management. The volume (e.g., amount, numerical quantity) and complexity of cryptographic keys generated for exchange of data between various devices (e.g., the server system 104, partner computing devices 106, and the computing device 102) exceeds human capabilities for efficient generation and management. Further, manual key generation is susceptible to human error, leading to weak cryptographic keys or improper key distribution. Additionally, or alternatively, manual processes may not account for evolving security standards and rapid scaling of digital systems, creating potential security gaps. To address the errors, delays, and inconsistencies related to manual cryptographic key generation, the computing device 102 implements a cryptographic key manager 116 to automatically manage cryptographic key generation, activation, and deployment between the computing device 102 and the partner computing devices 106. The computing device 102 implementing the cryptographic key manager 116 reduces, or eliminates, human error, improves efficiency, and enhances overall security in cryptographic operations.

The cryptographic key manager 116 at the computing device 102 leverages cryptographic key generation algorithms and machine learning techniques to automate the lifecycle of cryptographic keys 114. The cryptographic key manager 116 can generate one or more cryptographic keys 114 that satisfy various policies (e.g., criterion), manage distribution of the cryptographic keys 114, monitor expiration timelines for cryptographic keys 114, and initiate renewal processes for the cryptographic keys 114. The cryptographic key manager 116 implements a learning model 118 to analyze patterns in usage of the cryptographic keys 114 and security policies of partner computing devices 106, as well as the computing device 102, to perform generation and management of the cryptographic keys 114. For example, the learning model 118 may predict when cryptographic keys 114 are to expire, providing for proactive key generation and distribution to minimize latency in secure communications (e.g., exchange of the data 112).

Although the computing device 102 is illustrated as implementing the cryptographic key manager 116, the server system 104 may additionally, or alternatively, implement a cryptographic key manager 116 to generate and manage cryptographic keys 114. For example, at the server system 104, the cryptographic key manager 116 may perform centralized key management, coordinating key operations across multiple devices and systems, including the computing device 102 and the partner computing devices 106. The server system 104 can implement more complex learning models 118 (e.g., when compared with the computing device 102), due to advanced processing capabilities at the server system 104. The cryptographic key manager 116 at the server system 104 may use the learning models 118 to analyze global patterns in cryptographic key usage and security threats, providing insights that inform cryptographic key management policies across a network of devices (e.g., including the computing device 102 and the partner computing devices 106). The cryptographic key manager 116 at the server system 104 may store the cryptographic keys 114 in server data storage in addition to, or as an alternative to, respective computing devices storing the cryptographic keys 114 in local data storage at the respective computing devices.

The cryptographic key manager 116 may be implemented at least partially in hardware and/or software at the computing device 102 and/or at the server system 104. At the server system 104, the cryptographic key manager 116 may be implemented using processors and security logic, such as hardware security modules. The server system 104 may use database systems (e.g., including data storage 120) for secure cryptographic key storage and distributed computing frameworks for parallel processing of cryptographic operations. The server system 104 may implement cryptographic libraries, machine learning frameworks, and algorithms for cryptographic key management. The computing device 102 may implement the cryptographic key manager 116 using one or more processors and memory (e.g., data storage 122). The software implementation on the computing device 102 may include cryptographic libraries, learning models 118 that may be relatively small (e.g., quantized, less than a threshold numerical quantity of parameters) based on a capability of the computing device 102, and secure storage mechanisms.

The data storage 120 at the server system 104 serves as a secure repository for cryptographic keys 114, learning models 118 (e.g., parameter values that define the learning models 118, including weights and biases), cryptographic key management policies, and training data for the learning models 118. The data storage 122 at the computing device 102 may store locally relevant cryptographic keys 114, learning models 118, data 112, as well as criterion and/or policies used to generate the cryptographic keys 114. The server system 104 can train learning models 118 using the aggregated data from multiple devices and systems, then distribute learning models 118 to respective computing devices, including the computing device 102. For example, the server system 104 may train a learning model 118 to generate one or more cryptographic keys 114 and/or one or more suggestions for generating the cryptographic keys 114 using criterion or policies defined for the cryptographic key 114.

The learning model 118 may include a machine learning algorithm, an artificial intelligence algorithm (e.g., including neural networks), or any other computer algorithm trained to perform cryptographic key management. For example, the learning model 118 may include one or more large language models (LLMs), where an LLM is a type of artificial intelligence model trained on a relatively large amount of text data (e.g., greater than a threshold amount of text data). An LLM may be capable of understanding, generating, and manipulating human-like text across a wide range of topics and tasks. An LLM may utilize deep learning techniques, often based on neural network architectures, to process and generate natural language. LLMs may be employed in various applications, including but not limited to text generation, language translation, question answering, and text summarization. In some cases, an LLM may be integrated into systems for analyzing and generating complex text-based information, such as in the context of cryptographic key management and security policy analysis. The server system 104 may train one or more learning models 118 on diverse datasets, including historical key usage patterns, security incident reports, and evolving cryptographic standards. The training process may involve supervised learning, where the model is presented with labeled examples of effective and ineffective cryptographic key generation and/or management. For example, the learning model 118 might be trained to recognize patterns that indicate to perform cryptographic key rotation, or to identify cryptographic key attributes (e.g., cryptographic key lengths and algorithms) for different types of data and communication channels.

A learning model manager 124 at the server system 104 manages the training, evaluation, and distribution of learning models 118. The learning model manager 124 may use techniques, such as federated learning, to improve models while preserving data privacy. Federated learning is a machine learning technique that enables training learning models 118 across multiple decentralized devices or servers holding local data samples, without exchanging the raw training data. The learning model manager 124 can assess the capabilities of a computing device 102 (e.g., processing power, memory, security features) and determine which version of a learning model 118 or which learning model 118 to deploy to the computing device 102. For example, the learning model manager 124 may receive signaling from the computing device 102 that indicates the capabilities of the computing device 102 to implement the learning model 118, including a processing capability of the computing device 102, a memory capability of the computing device 102, a power capability of the computing device, and/or one or more security features implemented at the computing device 102. The learning model manager 124 selects a learning model 118 to transmit to the computing device 102 that satisfies the capabilities of the computing device 102, such that a processing capability, memory capability, or power capability, of the computing device is not exceeded.

The communications manager 126 at the server system 104 manages secure transmission of learning models 118, cryptographic keys 114, and management policies (e.g., criterion) to a computing device 102 and/or to one or more partner computing devices 106. The communications manager 128 at the computing device 102 manages secure connections for cryptographic key exchange and encrypted data transmission (e.g., exchange of the data 112). For example, the communications manager 128 may establish a connection with a communications manager 130 at a partner computing device 106. The communications manager 128 may receive partner criterion 132 from the partner computing device 106 via the communications manager 130. The computing device 102 may store the partner criterion 132 at the data storage 122 for use in generating cryptographic keys 114 for exchange of the data 112 between the computing device 102 and the partner computing device 106. The computing device 102 uses an active public cryptographic key of the partner computing device 106 (e.g., a current public cryptographic key or an updated public cryptographic key) for encryption and an updated private cryptographic key for signing.

The communications manager 130 at the partner computing device 106 may ensure compatibility with cryptographic key management protocols (e.g., the partner criterion 132) used by the computing device 102 and server system 104. The communications manager 126, the communications manager 128, and the communications manager 130 may be implemented at least partially by hardware and/or software components of the server system 104, the computing device 102, and the partner computing device 106, respectively. For example, the communications manager 126, the communications manager 128, and the communications manager 130 may be implemented by one or more transmission and/or reception hardware components, such as antennas, as well as one or more processors of the respective devices and systems. Additionally, or alternatively, the communications manager 126, the communications manager 128, and the communications manager 130 may be implemented in logic or other computer executable instructions exchanged between the respective devices and the systems to process communications between the devices and the systems.

The partner criterion 132 may include data or other information defining security policies (e.g., requirements) specified by the partner computing devices 106 for cryptographic key deployment. The partner criterion 132 and/or the criterion 134 may include, but is not limited to, key lengths, algorithms, use cases for the cryptographic key, or validity periods. The criterion 134 may include data or other information defining security policies specified by the computing device 102 (e.g., key lengths, algorithms, or validity periods). For example, a partner criterion 132 may include a minimum key length of 2048 bits for keys generated using a Rivest-Shamir-Adleman algorithm, while a criterion 134 from the computing device 102 may include a different key length or a use of another cryptographic algorithm (e.g., an elliptic curve cryptography algorithm, among other examples). The cryptographic key manager 116 provides the partner criterion 132 and the criterion 134 as input to the learning model 118. The learning model 118 generates one or more cryptographic keys 114 that satisfy both sets of criterion.

The computing device 102 can display one or more suggestions regarding the generated cryptographic at a user interface 136 of the computing device 102. The user interface 136 provides for user interaction with the cryptographic key manager 116. The user interface 136 may display suggestions generated by the learning models 118, such as recommended cryptographic key rotation schedules or proposed changes to attributes of cryptographic keys 114. The user interface 136 may show metadata related to cryptographic keys 114, such as a creation date, expiration date, or usage statistics. The computing device 102 may include an I/O manager 138 to manage input and output operations for the computing device 102. The I/O manager 138 may receive user input via the user interface 136, such as approval or rejection of suggested key management actions. The I/O manager 138 also manages the secure input and output of cryptographic keys 114 and encrypted data (e.g., the data 112). Examples of input may include, but are not limited to, receiving touch input in relation to portions of a displayed user interface (e.g., the user interface 136), receiving one or more voice commands or other audio input, receiving typed input, including via a physical or virtual (“soft”) keyboard, receiving mouse or stylus input, and so forth.

By leveraging machine learning through the learning model 118, the computing device 102 can adapt to changing security criterion (e.g., policies, requirements) and improve cryptographic key management in real-time. The automated processes reduce human error and improve the efficiency of cryptographic key generation and distribution by accounting for both the partner criterion 132 and the criterion 134 when generating the cryptographic keys 114 using the learning models 118. The server system 104 may deploy learning models 118 at both the server system 104 and computing devices 102, which may be referred to as a distributed architecture. The distributed architecture provides for both centralized policy enforcement and localized decision-making to improve security by minimizing the transmission of sensitive cryptographic keys 114, while enabling real-time or near real-time response (e.g., less than a threshold time period) for cryptographic key management tasks, including generation, activation, and deployment of the cryptographic keys 114.

Having considered an example of an environment, consider now a discussion of some example details of the techniques for automatically updating cryptographic keys using a learning model in accordance with one or more implementations.

### Updating Cryptographic Keys Using a Learning Model

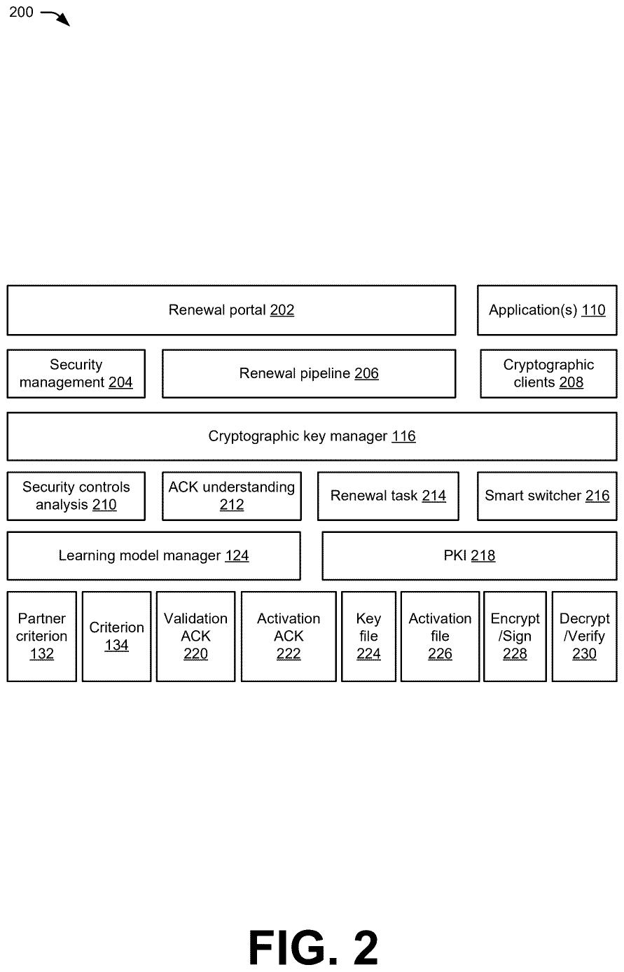

FIG. 2 depicts an environment 200 in an example implementation that is operable to employ techniques described herein. The environment 200 may implement, or be implemented by, aspects of FIG. 1. For example, the environment 200 may be implemented by a computing device, such as the computing device 102 as described with reference to FIG. 1. The environment 200 may include one or more applications 110, a cryptographic key manager 116, a learning model manager 124, partner criterion 132, and criterion 134, which may be examples of the corresponding devices and features as described with reference to FIG. 1.

The environment 200 includes a renewal portal 202, which may include a platform or dashboard displayed via a user interface, such as the user interface 136 of a computing device 102, as described with reference to FIG. 1. In some cases, the renewal portal 202 may include an output at a graphical user interface or an application 110 (e.g., a web application), that facilitates the management and renewal of cryptographic keys. The renewal portal 202 may display (e.g., output, present, show) notifications for upcoming expiration of cryptographic keys, display options for attribute selection for cryptographic keys, display a status of an ongoing renewal processes, and/or provide interfaces for approving or rejecting suggested updates to cryptographic keys. For example, the renewal portal 202 may be displayed at a user interface of a computing device, providing for a user to interact with the cryptographic key manager 116 to initiate, monitor, and control cryptographic key renewal processes.

The cryptographic key renewal process may include, but is not limited to, replacing one or more existing (e.g., current, original) cryptographic key pairs (e.g., pretty good privacy (PGP) cryptographic key pairs) with new cryptographic key pairs before the cryptographic key pairs expire or become compromised. The cryptographic key renewal processes includes generating a new or updated public and private cryptographic key pair, distributing the new public cryptographic key to relevant devices, and updating systems and devices to use one or more of the updated cryptographic keys, such as an updated cryptographic key pair, for encryption and decryption, as well as for digital signature and verification (e.g., encoding and decoding).

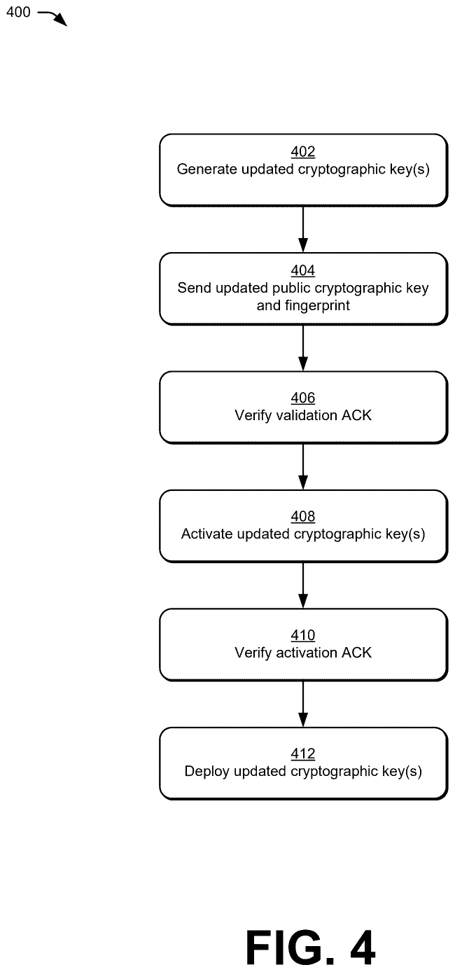

The renewal portal 202 implements a security management function 204 and a renewal pipeline 206 to manage the lifecycle of cryptographic keys. The security management function 204 may refer to a set of tools and processes for security of cryptographic keys, such as enforcing security policies, managing access controls, and ensuring compliance with security standards. For example, the security management function 204 may validate that generated cryptographic keys satisfy (e.g., meet) defined criterion, including the partner criterion 132 and the criterion 134, which may be examples of the partner criterion 132 and the criterion 134, as described with reference to FIG. 1. The renewal pipeline 206 represents the process for generating, activating, and deploying cryptographic keys, which is described in further detail with respect to FIG. 4. The renewal pipeline 206 includes, but is not limited to, cryptographic key generation, validation, activation, and deployment. The renewal portal 202 may display a status or progress of the renewal pipeline 206 via a user interface. For example, renewal portal 202 may display a progress bar indicating a current status of a cryptographic key renewal process, from generation to deployment.

The renewal portal 202, security management function 204, renewal pipeline 206, and cryptographic clients 208 may be implemented within an application 110 (e.g., at a computing device and/or a server system). Cryptographic clients 208 may refer to various entities or systems that interact with the cryptographic key management system, such as partner computing devices 106, as described with reference to FIG. 1, internal systems that implement cryptographic key management services, or other applications 110 that perform secure communication. For example, a cryptographic client 208 may include a payment processing system with cryptographic key updates to maintain secure transactions.

The cryptographic key manager 116 (e.g., also referred to as a PKI agent) coordinates cryptographic key generation and usage for data exchange between devices. The cryptographic key manager 116 performs security controls analysis 210, which involves evaluating and enforcing security policies and criterion (e.g., requirements) for key generation and usage. The cryptographic key manager 116 may leverage machine learning techniques to manage cryptographic keys. For example, the cryptographic key manager 116 may use predictive analytics to anticipate when cryptographic keys are likely to expire or become vulnerable and to initiate proactive cryptographic key renewal processes. Additionally, or alternatively, the cryptographic key manager 116 may analyze patterns in cryptographic key usage and security incidents to refine cryptographic key generation attributes (e.g., features, parameters) and improve data security over time.

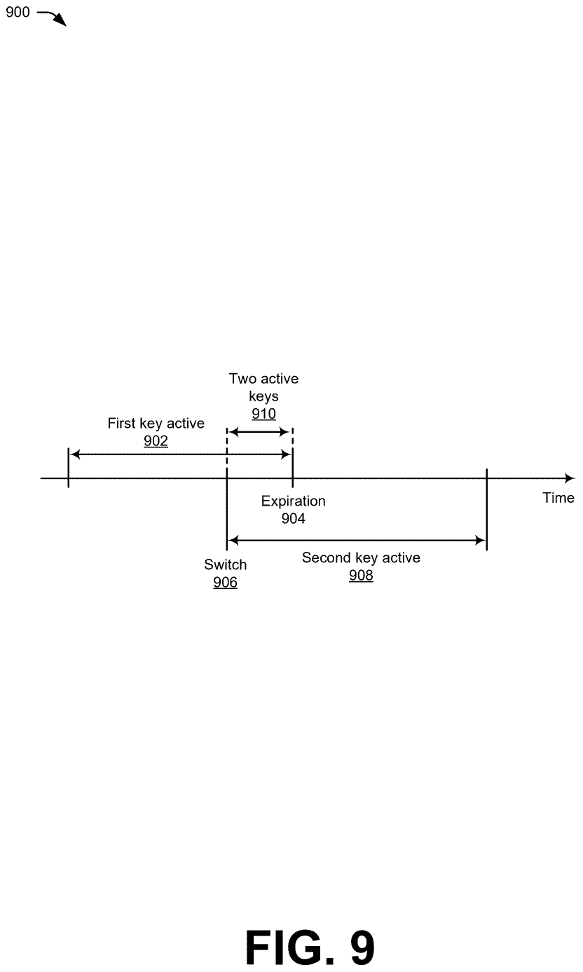

The cryptographic key manager 116 may perform acknowledgment (ACK) understanding 212 to interpret feedback messages received during the cryptographic key renewal process, ensuring proper validation and activation of new cryptographic keys. Additionally, or alternatively, the cryptographic key manager 116 may perform renewal tasks 214, including various operations for updating and managing cryptographic keys throughout a lifecycle. The renewal tasks 214 may include, but not limited to, generating new cryptographic keys, rotating existing (e.g., current) cryptographic keys, revoking compromised cryptographic keys, and updating cryptographic key attributes. In some cases, the cryptographic key manager 116 may implement a smart switcher 216 to enable transitions between current cryptographic keys and new cryptographic keys, reducing or eliminating disruptions to ongoing secure communications. In some cases, the smart switcher 216 may implement a grace period where both current cryptographic keys and new cryptographic keys are valid, providing for gradual migration of systems to the updated cryptographic keys, which is described in further detail with respect to FIG. 9. The smart switcher 216 may perform rollback procedures to previously used cryptographic keys when errors occur with newly deployed cryptographic keys, ensuring continuity of communications and corresponding operation.

The cryptographic key manager 116 leverages a learning model manager 124 to incorporate machine learning capabilities into cryptographic key management processes. The cryptographic key manager 116 leverages the learning model manager 124 to enhance cryptographic key management processes through various machine learning techniques. For example, the learning model manager 124 may use partner criterion 132 and criterion 134 as input to learning models that generate cryptographic keys satisfying security specifications of both a computing device 102 and one or more partner computing devices. The learning model may analyze historical cryptographic key usage patterns, security incident reports, and evolving cryptographic standards to make informed decisions about cryptographic key attributes. For example, if the learning model observes a trend of increasing cryptographic key lengths and the criterion 134 and the partner criterion 132 do not define a maximum cryptographic key length or define a maximum cryptographic key length as greater than a threshold value, then the learning model may output a recommended cryptographic key with a relatively long key length (e.g., greater than a threshold value and less than the maximum cryptographic key length if defined in the criterion 134 and/or the partner criterion 132). The cryptographic key manager 116 may also use the learning model to predict cryptographic key rotation schedules based on cryptographic key usage frequency, data sensitivity, and historical compromise patterns. For example, the learning model may generate a recommendation or suggestion for more frequent cryptographic key rotations for relatively high-traffic (e.g., greater than a threshold throughput) communication channels or recommending cryptographic key updates in response to detected security anomalies. Additionally, or alternatively, the learning model may analyze the partner criterion 132, the criterion 134, and one or more ACK messages during cryptographic key renewal processes to identify and resolve errors in the cryptographic key generation and renewal that may otherwise cause delays or errors in cryptographic key deployment. By continuously analyzing cryptographic key usage and deployment to adapt to new security criterion, the learning model enables the cryptographic key manager 116 to implement a proactive and dynamic approach to cryptographic key management, including identifying and mitigating security risks.

The cryptographic key manager 116 may implement a PKI 218 to perform the cryptographic operations using corresponding infrastructure for cryptographic key management. A PKI 218 refers to a system of digital certificates, certificate authorities, and other registration authorities that verify and authenticate the validity of parties (e.g., devices) involved in exchange of data. A PKI 218 includes hardware, software, policies, procedures, and other resources involved in the creation, management, distribution, use, storage, and revocation of digital certificates and public-private cryptographic key pairs. As part of PKI operations, a computing device may implement asymmetric cryptography techniques to generate cryptographic key pairs, including a public cryptographic key and a private cryptographic key. The public cryptographic key may be distributed to computing devices for encryption or signature verification, while the private cryptographic key may be kept secret and used for decryption and digital signing. The PKI 218 may include certificate issuance, where a trusted certificate authority creates and signs digital certificates binding public cryptographic keys to a defined entity or device. A PKI 218 may perform key distribution to transmit public cryptographic keys and certificates to intended entities or devices. Additionally, or alternatively, a PKI 218 may perform verification processes to ensure a validity and authenticity of digital certificates, including verifying the certificate chain and analyzing certificate revocation lists. The PKI 218 may perform cryptographic key revocation and renewal, managing the lifecycle of cryptographic keys to maintain security over time.

The cryptographic key manager 116 may determine whether one or more feedback messages are received prior to deploying a cryptographic key. For example, a validation ACK 220 and an activation ACK 222 are feedback messages received at different stages of the cryptographic key renewal process, confirming successful validation and deployment of new cryptographic keys, respectively. The key file 224 includes the cryptographic key data, while the activation file 226 may include information related to activate a newly generated cryptographic key. For example, the activation file 226 may include, but is not limited to, activation timestamps, cryptographic key identifiers (IDs), authorized users or systems, activation codes, or configuration parameters for enabling and integrating the newly generated cryptographic key into an existing security infrastructure. A computing device may use the key file 224 and the activation file 226 to encrypt/sign 228 outgoing data and/or to decrypt/verify 230 incoming data. For example, when exchanging sensitive financial data with a partner computing device, the cryptographic key manager 116 may use a key file 224 to encode the data before transmission, ensuring a confidentiality and integrity of the data.

### Procedures for Updating Cryptographic Keys Using a Learning Model

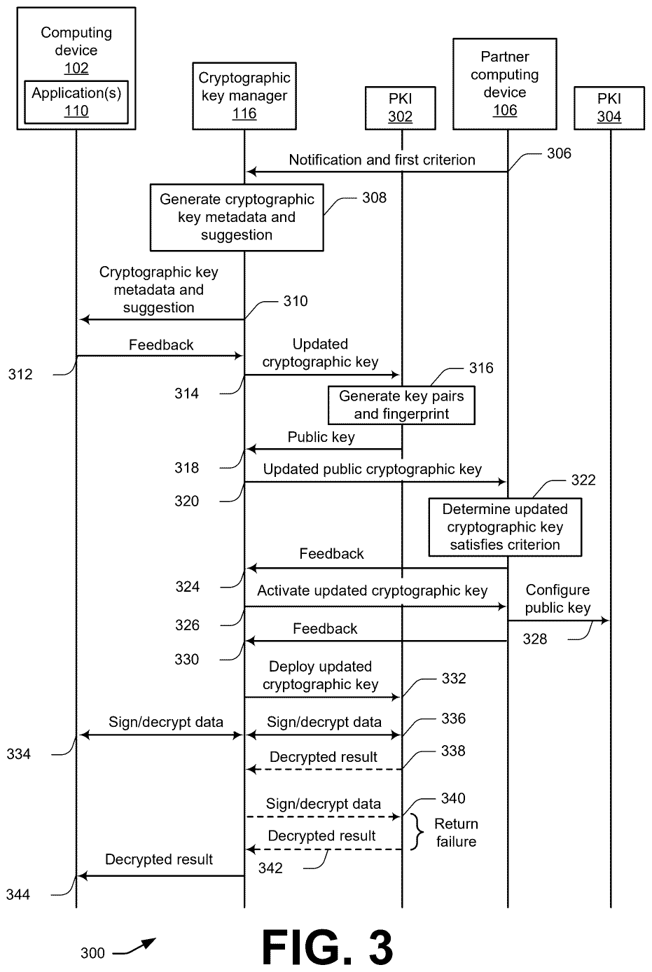

FIG. 3 depicts an example procedure 300 for automatically updating cryptographic keys using a learning model. The procedure 300 may be implemented by aspects of FIGS. 1 and 2. For example, the procedure 300 may be implemented by a computing device 102 (e.g., one or more applications 110 at the computing device 102), a server system, a cryptographic key manager 116, and a partner computing device 106, such as the computing device 102, applications 110, the server system 104, a cryptographic key manager 116, and a partner computing device 106, as described with reference to FIGS. 1 and 2. The procedure 300 may also be implemented by a PKI 302 and/or a PKI 304, where the PKI 302 is implemented by a computing device 102 and/or a server system of the computing device 102, and the PKI 304 is implemented by a partner computing device 106 and/or a server system of the partner computing device 106.

In some examples, a computing device 102 may implement a cryptographic key manager 116 (e.g., also referred to as a PKI agent) to analyze cryptographic workloads, while maintaining resilience to changes during the processing of cryptographic requests. Implementing the cryptographic key manager 116 ensures seamless operations without halting activities during transition periods between cryptographic keys. Additionally, or alternatively, the cryptographic key manager 116 functions as an interface between services (e.g., a service supported by the computing device 102 and a service supported by the partner computing device 106). The cryptographic key manager 116 may perform security analysis and recommendations, may perform feedback message interpretation (e.g., ACK interpretation), and may function as a key management proxy.

In some examples, the cryptographic key manager 116 leverages one or more learning models (e.g., an LLM) to account for both internal and external criterion (e.g., policies, standard operating procedure controls) that define attributes of the cryptographic keys. The cryptographic key manager 116 is capable of generating key specification metadata as suggestions, accompanied by rationales. In the key rotation process, the cryptographic key manager 116 establishes a flexible, multi-specification handshake, ensuring compatibility and security. The cryptographic key manager 116 generates, sends, activates, and deploys cryptographic keys by seamlessly integrating with both the PKI and portals or endpoints of a partner service (e.g., the partner computing device 106). By using the LLM, the cryptographic key manager 116 interprets varied feedback responses, effectively managing and holding the renewal process.

At 306, a partner computing device 106 sends a notification and first criterion to the cryptographic key manager 116.

The notification may include an electronic (e.g., digital) message, such as an email, a text message, or other electronic communication sent to the cryptographic key manager 116. Upon receiving the notification, the cryptographic key manager 116 may use a learning model to process and interpret the notification content and the associated first criterion. In some cases, the notification may include an explicit indication of the first criterion. In some other cases, the notification may not include the first criterion, and instead the cryptographic key manager 116 may access an online database or repository to retrieve the first criterion based on IDs of the partner computing device 106 included in the notification.

At 308, the cryptographic key manager 116 generates metadata and a suggestion for an updated cryptographic key, such as based on the first criterion and second criterion. The cryptographic key manager 116 may utilize a learning model, such as a machine learning algorithm or artificial intelligence model, to analyze the first criterion received from the partner computing device 106 and the second criterion stored locally at the computing device 102 and/or at the cryptographic key manager 116. The learning model may be trained on historical cryptographic key generation data and security policies. In some cases, the cryptographic key manager 116 may generate metadata for one or more new or updated cryptographic keys, as well as a recommendation and/or suggestion that indicates a reason for the metadata. The cryptographic key manager 116 may generate multiple candidate cryptographic keys and use the learning model to select a cryptographic key from the candidates, where the selected cryptographic key satisfies (e.g., meets) the criterion.

At 310, the cryptographic key manager 116 sends the metadata and suggestion to the computing device 102. Additionally, or alternatively, the cryptographic key manager 116 may send an updated (e.g., newly generated) cryptographic key to the computing device 102 for review. For example, the cryptographic key manager 116 may send an explicit indication of the cryptographic key, metadata of the cryptographic key, and/or a suggestion related to the cryptographic key that includes a reason for generating the cryptographic key. The computing device 102 may display the information received from the cryptographic key manager 116 via a user interface (e.g., for review by a user).

At 312, the cryptographic key manager 116 may receive feedback related to the metadata, the suggestion, and/or the cryptographic key. For example, the computing device 102 may receive input at an interactive element displayed at the user interface that indicates the generated cryptographic key is accepted or not accepted (e.g., rejected). Additionally, or alternatively, the cryptographic key manager 116 may determine whether the generated cryptographic key is accepted or rejected according to whether the cryptographic key satisfies the criterion or not, respectively (e.g., without user input). The cryptographic key manager 116 may generate an additional cryptographic key if the suggestion is rejected. In some other cases, the cryptographic key manager may trigger a rotation pipeline if the cryptographic key is accepted.

At 314, if the cryptographic key is accepted, then the cryptographic key manager 116 transmits the updated cryptographic key to a PKI 302. At 316, the PKI 302 generates cryptographic key pairs, which may include a public cryptographic key, a private cryptographic key, and a corresponding fingerprint. The process may include generating a series or sequence of characters and/or numbers using a mathematical algorithm to ensure the security and uniqueness of the cryptographic key pair.

At 318, the PKI 302 transmits the public cryptographic key to the cryptographic key manager 116. The public cryptographic key may be distributed to multiple devices, while a private cryptographic key remains securely stored at a single device.

At 320, the cryptographic key manager 116 transmits the updated public cryptographic key to the partner computing device 106.

At 322, the partner computing device determines if the updated public cryptographic key satisfies the criterion for the partner computing device 106. The verification process may include determining whether a key length, an algorithm type, an expiration date, and other security parameters satisfy (e.g., meet) the criterion.

At 324, the partner computing device 106 transmits feedback to the cryptographic key manager 116. The feedback can include a validation ACK that indicates the cryptographic key satisfies the criterion.

At 326, the cryptographic key manager 116 transmits instructions to activate the updated cryptographic key. The activation may include updating key management systems, configuring security protocols, and synchronizing the new cryptographic key across relevant systems and devices. For example, at 328, the partner computing device 106 configures the newly generated public cryptographic key at the PKI 304. Configuring the newly generated public cryptographic key may include, but is not limited to, updating public cryptographic key repositories, certificate authorities, or other PKI components.

At 330, the partner computing device 106 transmits feedback to the cryptographic key manager 116. For example, the partner computing device 106 transmits a deployment ACK that indicates the cryptographic key is successfully configured at the PKI 304. At 332, the cryptographic key manager 116 deploys the updated cryptographic key. For example, the cryptographic key manager 116 deploys the updated cryptographic key at the PKI 302 responsive to the deployment ACK. Deployment may include distributing the cryptographic key to relevant devices and systems, as well as updating encryption and decryption processes.

At 334 and at 336, an application 110 of the computing device 102 uses the updated cryptographic key to sign (e.g., encrypt) and/or decrypt data at the cryptographic key manager 116 and the PKI 302. The data may come from various sources and may be in different formats. The computing device 102 may use different encryption or decryption schemes at the application 110, the cryptographic key manager 116, and the PKI 302 depending on the source and/or format of the data.

In some cases, at 338, the PKI 302 returns decrypted results to the cryptographic key manager 116, such as if the PKI 302 successfully decrypts the data. However, in some other cases, at 340, the cryptographic key manager 116 may send the signed or decrypted data to the PKI 302 again if there is a return failure. At 342, the cryptographic key manager 116 receives the decrypted result from the PKI 302 based on the return failure. At 344, the cryptographic key manager 116 returns the decrypted result to the application 110 at the computing device 102. The application 110 may process the decrypted result. For example, the application 110 may display the decrypted information to a user via a user interface of the computing device, store the decrypted data in a secure database, use the decrypted information to authenticate a user or authorize a transaction, or incorporate the decrypted data into a report or other document. In some cases, the application 110 may also trigger additional actions or workflows based on the content of the decrypted result, such as initiating a communication with another system or updating internal records.

FIG. 4 depicts an example procedure 400 for automatically updating cryptographic keys using a learning model. The procedure 400 may be implemented by aspects of FIGS. 1 through 3. For example, the procedure 400 may be implemented by a computing device and/or a server system, such as the computing device 102 and/or the server system 104, as described with reference to FIG. 1. The example procedure 400 may be an example of the renewal pipeline 206, as described with reference to FIG. 2.

At 402, a computing device generates one or more updated cryptographic keys (e.g., an updated public cryptographic key for use at the computing device and to share with one or more partner computing devices and an updated private cryptographic key for use at the computing device). Additionally, or alternatively, the partner computing device generates one or more updated cryptographic keys (e.g., an updated public cryptographic key for use at the partner computing device and to share with the computing device and an updated private cryptographic key for use at the partner computing device). An updated cryptographic key pair can include a private cryptographic key, which is stored and used at a single device (e.g., respective private cryptographic keys for the computing device and the partner computing device), and a public cryptographic key, which each device generates and distributes to one or more other devices.

In some cases, the computing device can implement multiple cryptographic key pairs (e.g., a current cryptographic key pair and an updated cryptographic key pair). The partner computing device can implement a current cryptographic key pair. The current cryptographic key pair implemented by the computing device can include a current private cryptographic key, esk1, and a current public cryptographic key, epk1. The updated cryptographic key pair implemented by the computing device can include an updated private cryptographic key, esk2, and an updated public cryptographic key, epk2. The partner computing device can rotate a cryptographic key pair implemented by the partner computing device (e.g., regardless of using a learning model). Thus, the partner computing device can implement a current or updated private cryptographic key, vsk, and a current or updated public cryptographic key, vpk. The computing device transmits a public cryptographic key (e.g., at least one of epk1 or epk2) to the partner computing device and holds (e.g., stores, maintains, implements) a corresponding private cryptographic key (e.g., at least one of esk1 or esk2). The partner computing device transmits the public cryptographic key, vpk, to the computing device and holds the private cryptographic key, vsk.

For an inbound data transmission to the computing device, the partner computing device encrypts the data using epk1 before a defined time period (e.g., according to a cryptographic key expiration or rotation date, timeline, and/or schedule) and epk2 after the defined time period. The partner computing device uses vsk to sign the data transmission. The computing device uses esk1 or esk2 to perform decryption (e.g., where files can be delayed when receiving, as described with reference to FIG. 9) and vpk to verify the inbound data transmission. The partner computing device may perform one or more of the processes described as being performed by the computing device, and vice-versa, for an inbound data transmission to the partner computing device.

For an outbound data transmission from the computing device, the computing device encrypts the data using a public cryptographic key of a partner computing device, vpk. The computing device signs the data using esk1 before a defined time period (e.g., according to a cryptographic key expiration or rotation date, timeline, and/or schedule) and esk2 after the defined time period. The partner computing device decrypts the data using vsk and verifies the data using epk1 or epk2 (e.g., where files can be delayed when receiving, as described with reference to FIG. 9). The partner computing device may perform one or more of the processes described as being performed by the computing device, and vice-versa, for an outbound data transmission from the partner computing device.

The computing device may use a learning model, such as a machine learning algorithm or artificial intelligence model, to analyze criterion received from a partner computing device and criterion stored locally at the computing device. In some cases, the computing device provides standard operating procedures documents as input to the learning model, and the learning model analyzes the documents to determine the criterion and generate updated (e.g., new) cryptographic keys that satisfy the criterion. A server system and/or the computing device may train the learning model using historical cryptographic key generation data and security policies and/or criterion. In some cases, the computing device may generate multiple candidate cryptographic keys and use the learning model to select a cryptographic key based on the criterion.

At 404, the computing device sends an updated public cryptographic key and a corresponding fingerprint to a partner computing device. For example, the computing device may send an explicit indication of the cryptographic key, metadata of the cryptographic key, and/or a suggestion related to the cryptographic key that includes a reason for generating the cryptographic key. The partner computing device may display the information received from the computing device via a user interface for review.

At 406, the computing device receives a validation ACK from the partner computing device. The validation ACK indicates that the updated cryptographic key satisfies the criterion for the partner computing device. The verification process may include determining whether a key length, an algorithm type, an expiration date, and other security parameters satisfy the criterion.

At 408, the computing device activates the updated cryptographic keys (e.g., an updated public cryptographic key and/or an updated private cryptographic key). The activation may include updating cryptographic key management systems, configuring security protocols, and synchronizing the new cryptographic key across relevant systems and devices. For example, the computing device may configure the newly generated public cryptographic key at a PKI. Configuring the newly generated public cryptographic key may include, but is not limited to, updating public cryptographic key repositories, certificate authorities, or other PKI components.

At 410, the computing device receives an activation ACK from the partner computing device. The activation ACK indicates that the updated cryptographic keys are successfully configured at a PKI of a partner computing device or other relevant systems.

At 412, the computing device deploys the updated cryptographic keys. Deployment may include distributing updated cryptographic keys to relevant devices and systems, as well as updating encryption and decryption processes. The computing device may use the updated cryptographic keys to encrypt and sign (e.g., encode) and/or decrypt and verify (e.g., decode) data. The data may come from various sources and may be in different formats. The computing device may use different encryption or decryption schemes depending on the source and/or format of the data.

### Architectures for Updating Cryptographic Keys Using a Learning Model

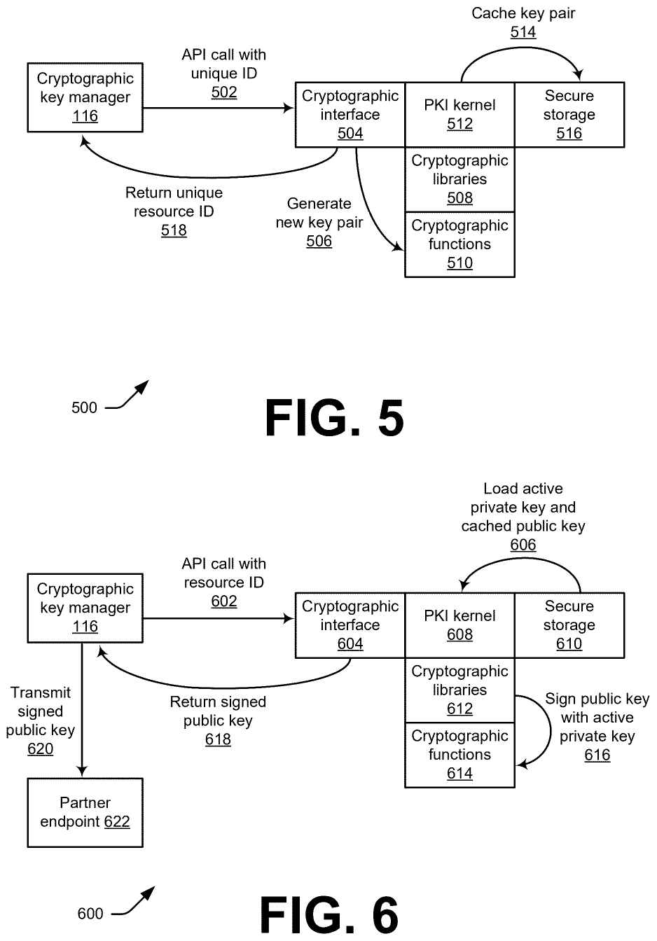

FIG. 5 depicts an example architecture 500 for automatically updating cryptographic keys using a learning model. The architecture 500 may implement, or may be implemented by, aspects of FIGS. 1 through 4. For example, the architecture 500 may implement a cryptographic key manager 116 at a computing device and/or a server system, such as the cryptographic key manager 116 implemented at the computing device 102 and/or the server system 104, as described with reference to FIG. 1. The architecture 500 illustrates an example of an architecture 500 for generating one or more cryptographic keys.

A cryptographic key manager 116 in the architecture 500 processes an application programming interfaces (API) call with a unique ID to generate a new (e.g., updated) cryptographic key pair. At 502, the cryptographic key manager 116 sends the API call with the unique ID to a cryptographic interface 504. The cryptographic interface 504 may be an example of a component of the cryptographic key manager 116, as described with reference to FIG. 1.

At 506, the cryptographic interface 504 generates a new cryptographic key pair based on the API call. The new key pair may include a public cryptographic key and a private cryptographic key for use in asymmetric cryptography. The cryptographic interface 504 interacts with multiple components to generate and process the new cryptographic key pair, including cryptographic libraries 508, cryptographic functions 510, and a PKI kernel 512. The cryptographic libraries 508 may include one or more collections of pre-written code, algorithms, and functions that provide implementations of various cryptographic operations and protocols. The cryptographic libraries 508 may include functions for encryption, decryption, digital signatures, key generation, and other cryptographic processes.

The cryptographic functions 510 include defined functions within a cryptographic library (e.g., a bouncy castle cryptographic library) that provide a set of cryptographic APIs. The cryptographic functions 510 include, but are not limited to, symmetric and asymmetric encryption, digital signatures, certificate handling, and various cryptographic protocols. A PKI kernel 512 may refer to a component of a PKI system that manages the creation, distribution, and revocation of digital certificates and cryptographic key pairs. The PKI kernel 512 may perform certificate issuance, validation, and storage, as well as maintaining certificate revocation lists. The PKI kernel 512 may interact with various other components of the cryptographic system, including certificate authorities, registration authorities, and certificate repositories.

At 514, the PKI kernel 512 caches the newly generated cryptographic key pair in secure storage 516. The secure storage 516 maintains a secure repository of cryptographic keys, providing for efficient retrieval and management of cryptographic keys. The caching of the new key pair in secure storage provides for relatively prompt access (e.g., within a threshold duration) and use of the cryptographic keys in future cryptographic operations.

At 518, the cryptographic interface 504 returns a unique resource ID to the cryptographic key manager 116. The unique resource ID references the newly generated and cached cryptographic key pair, providing for the cryptographic key manager 116 to access and utilize the new cryptographic keys for future encryption, decryption, or digital signing operations.

FIG. 6 depicts an example architecture 600 for automatically updating cryptographic keys using a learning model. The architecture 600 may implement, or may be implemented by, aspects of FIGS. 1 through 5. For example, the architecture 600 may implement a cryptographic key manager 116 at a computing device and/or a server system, such as the cryptographic key manager 116 implemented at the computing device 102 and/or the server system 104, as described with reference to FIG. 1. The architecture 600 illustrates an example of an architecture 600 for sending a generated cryptographic key.

The architecture 600 includes a cryptographic key manager 116 that processes an API call with resource ID to sign a newly generated cryptographic key. At 602, the cryptographic key manager 116 sends the API call with the resource ID to a cryptographic interface 604. The cryptographic interface 604 may be an example of a component of the cryptographic key manager 116, as described with reference to FIGS. 1 and 5.

At 606, the cryptographic interface 604 loads an active private cryptographic key and the cached public cryptographic key based on the API call. The cryptographic interface 604 interacts with multiple components to sign and process the cryptographic keys and data, including a PKI kernel 608, secure storage 610, cryptographic libraries 612, and cryptographic functions 614, which may be examples of the corresponding features as described with reference to FIG. 5. The PKI kernel 608 may refer to a component of a PKI system that manages the creation, distribution, and revocation of digital certificates and cryptographic key pairs. The PKI kernel 608 may perform certificate issuance, validation, and storage, as well as maintaining certificate revocation lists.

The secure storage 610 maintains a secure repository of cryptographic keys, providing for efficient retrieval and management of cryptographic keys. The cryptographic libraries 612 may include one or more collections of pre-written code, algorithms, and functions that provide implementations of various cryptographic operations and protocols. The cryptographic libraries 612 may include functions for encryption, decryption, digital signatures, key generation, and other cryptographic processes.

The cryptographic functions 614 include defined functions within a cryptographic library that provide a set of cryptographic APIs. The cryptographic functions 614 include, but are not limited to, symmetric and asymmetric encryption, digital signatures, certificate handling, and various cryptographic protocols. At 616, the cryptographic functions 614 sign the public cryptographic key with the active private cryptographic key.

At 618, the cryptographic interface 604 returns the signed public cryptographic key to the cryptographic key manager 116. The signed public cryptographic key references the newly signed cryptographic key, providing for the cryptographic key manager 116 to access and use the signed cryptographic key for future encryption, decryption, or digital signing operations. At 620, the cryptographic key manager 116 transmits the signed public cryptographic key to a partner endpoint 622 for use in secure communications.

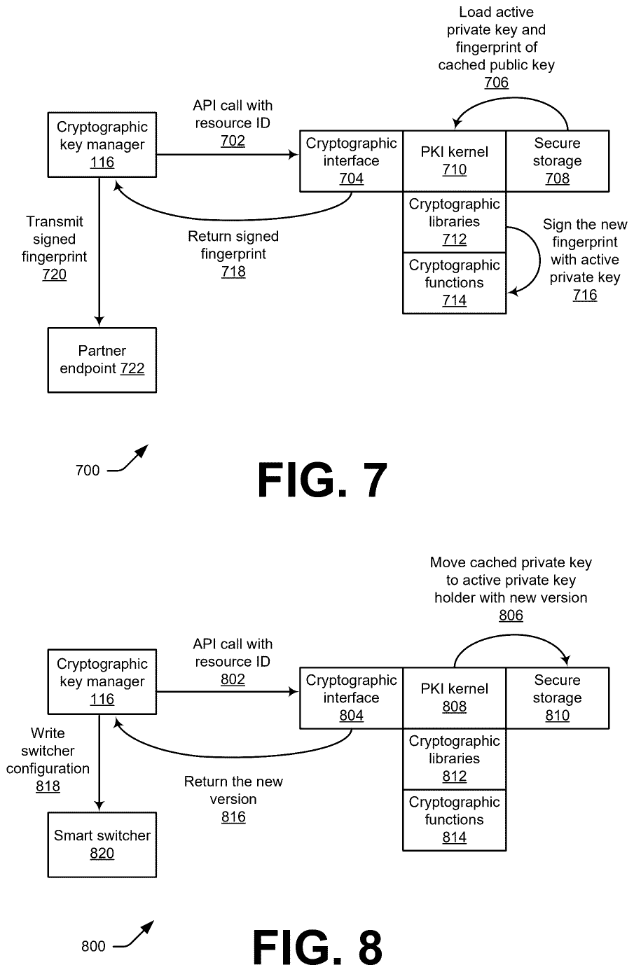

FIG. 7 depicts an example architecture 700 for automatically updating cryptographic keys using a learning model. The architecture 700 may implement, or may be implemented by, aspects of FIGS. 1 through 6. For example, the architecture 700 may implement a cryptographic key manager 116 at a computing device and/or a server system, such as the cryptographic key manager 116 implemented at the computing device 102 and/or the server system 104, as described with reference to FIG. 1. The architecture 700 illustrates an example of an architecture 700 for activating a generated cryptographic key.

The architecture 700 includes a cryptographic key manager 116 that processes an API call with resource ID to sign a fingerprint of a newly generated cryptographic key. At 702, the cryptographic key manager 116 sends the API call with the resource ID to a cryptographic interface 704. The cryptographic interface 704 may be an example of a component of the cryptographic key manager 116, as described with reference to FIGS. 1, 5 and 6.

At 706, the cryptographic interface 704 loads an active private cryptographic key and fingerprint of a cached public cryptographic key based on the API call. The cryptographic interface 704 interacts with multiple components to sign and process the fingerprint, including a secure storage 708, PKI kernel 710, cryptographic libraries 712, and cryptographic functions 714, which may be examples of the corresponding features as described with reference to FIGS. 5 and 6. The secure storage 708 maintains a secure repository of cryptographic keys, providing for efficient retrieval and management of cryptographic keys. The PKI kernel 710 may refer to a component of a PKI system that manages the creation, distribution, and revocation of digital certificates and cryptographic key pairs. The PKI kernel 710 may perform certificate issuance, validation, and storage, as well as maintaining certificate revocation lists.

The cryptographic libraries 712 may include one or more collections of pre-written code, algorithms, and functions that provide implementations of various cryptographic operations and protocols. The cryptographic libraries 712 may include functions for encryption, decryption, digital signatures, key generation, and other cryptographic processes.

The cryptographic functions 714 include defined functions within a cryptographic library that provide a set of cryptographic APIs. The cryptographic functions 714 include, but are not limited to, symmetric and asymmetric encryption, digital signatures, certificate handling, and various cryptographic protocols. At 716, the cryptographic functions 714 sign the new fingerprint with active private cryptographic key.

At 718, the cryptographic interface 704 returns the signed fingerprint to the cryptographic key manager 116. The signed fingerprint references the newly signed cryptographic key, providing for the cryptographic key manager 116 to access and utilize the signed key for future encryption, decryption, or digital signing operations. At 720, the cryptographic key manager 116 transmits the signed fingerprint to a partner endpoint 722 for use in secure communications.

FIG. 8 depicts an example architecture 800 for automatically updating cryptographic keys using a learning model. The architecture 800 may implement, or may be implemented by, aspects of FIGS. 1 through 7. For example, the architecture 800 may implement a cryptographic key manager 116 at a computing device and/or a server system, such as the cryptographic key manager 116 implemented at the computing device 102 and/or the server system 104, as described with reference to FIG. 1. The architecture 800 illustrates an example of an architecture 800 for deploying a generated cryptographic key.

The architecture 800 includes a cryptographic key manager 116 that processes an API call with resource ID to deploy a newly generated cryptographic key. At 802, the cryptographic key manager 116 sends the API call with the resource ID to a cryptographic interface 804. The cryptographic interface 804 may be an example of a component of the cryptographic key manager 116, as described with reference to FIGS. 1, 5, 6, and 7.

At 806, a PKI kernel 808 moves a cached private cryptographic key to an active private cryptographic key holder with a new version from secure storage 810. The secure storage 810 maintains a secure repository of cryptographic keys, providing for efficient retrieval and management of cryptographic keys. Moving the cached private cryptographic key to the active private cryptographic key holder enables the system to use the newly generated key for cryptographic operations.

The cryptographic interface 804 interacts with multiple components to deploy and process the cryptographic key, including cryptographic libraries 812 and cryptographic functions 814, where the PKI kernel 808, the secure storage 810, the cryptographic libraries 812, and the cryptographic functions 814 may be examples of the corresponding features, as described with reference to FIGS. 5, 6, and 7. The cryptographic libraries 812 may include one or more collections of pre-written code, algorithms, and functions that provide implementations of various cryptographic operations and protocols. The cryptographic libraries 812 may include functions for encryption, decryption, digital signatures, key deployment, and other cryptographic processes.

The cryptographic functions 814 include defined functions within a cryptographic library that provide a set of cryptographic APIs. The cryptographic functions 814 include, but are not limited to, symmetric and asymmetric encryption, digital signatures, certificate handling, and various cryptographic protocols related to key deployment and management.

At 816, the cryptographic interface 804 returns the new version to the cryptographic key manager 116. The new version references the newly deployed cryptographic key, providing for the cryptographic key manager 116 to access and use the new cryptographic key for future encryption, decryption, or digital signing operations.

At 818, the cryptographic key manager 116 writes switcher configuration to a smart switcher 820. The smart switcher 820 may manage the transition between the previous cryptographic key and the newly deployed key, ensuring continuity of cryptographic operations during the key update process.

### Timeline for Updating a Cryptographic Key Using a Learning Model

FIG. 9 depicts an example timeline 900 for automatically updating cryptographic keys using a learning model. The timeline 900 may implement, or may be implemented by, aspects of FIGS. 1 through 8. For example, the timeline 900 by implemented by a computing device and/or a server system, such as the computing device 102 and/or the server system 104, as described with reference to FIG. 1.

In some examples, switch time windows for switching (e.g., rotating) cryptographic keys are manually determined between services. However, manually determining switch time windows leads to increased signaling overhead related to communications between the different services (e.g., messages between users of computing devices), as well as increased latency due to halting related workflows temporarily to ensure a smooth transition. In some examples, to reduce signaling overhead and reduce latency related to manually switching cryptographic keys, a computing device may implement learning models and the timeline 900 to generate and switch cryptographic keys.

The timeline 900 illustrates the lifecycle and transition of cryptographic keys (e.g., a private cryptographic key and a public cryptographic key of a cryptographic key pair). The timeline 900 includes a time period 902 during which a first cryptographic key is active. The time period 902 extends from an initial duration to an expiration of the first cryptographic key at 904. At 906 a switch occurs, and a second cryptographic key becomes active for a time period 908. The switch may occur prior to expiration of the time period 902, such that two cryptographic keys are simultaneously active for a time period 910. The overlapping period provides for a smooth transition between cryptographic keys without interrupting ongoing operations.

The expiration indicates an end of an active lifecycle of the first cryptographic key (e.g., the time period 902), at which point a cryptographic key rotation or switch may be initiated. During the time period 910, both the original (e.g., current) cryptographic key and the new cryptographic key are valid, providing for systems and applications to gradually migrate to the updated cryptographic key without causing disruptions to ongoing secure communications or data exchanges.

### Example Procedures

This section describes examples of procedures for automatically updating cryptographic keys using a learning model. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

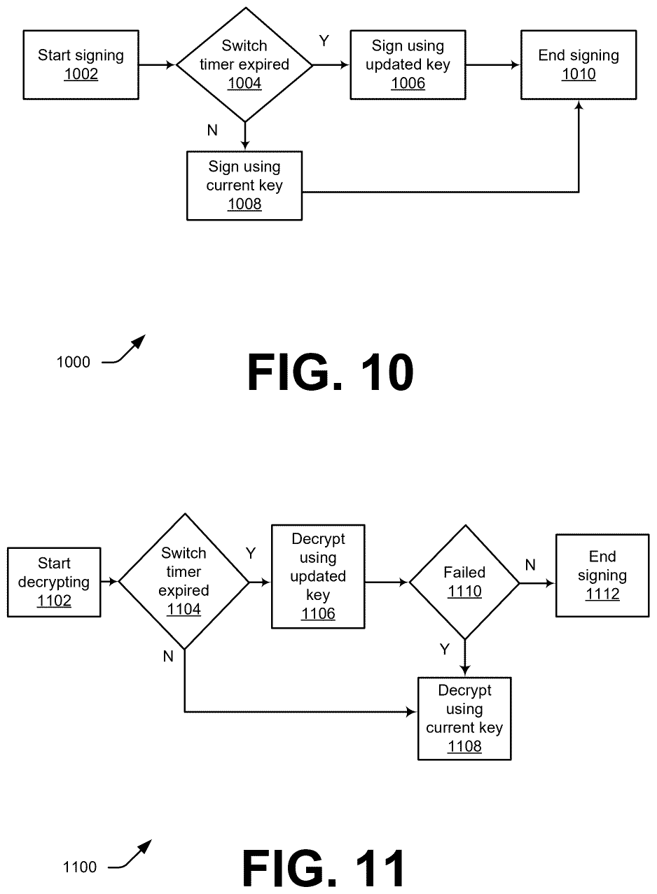

FIG. 10 depicts a procedure 1000 in an example implementation of automatically updating cryptographic keys using a learning model. The procedure 1000 may be implemented by, or may implement, aspects of FIGS. 1 through 9. For example, the procedure 1000 may be implemented by a computing device and/or a server system, which may be examples of a computing device 102 and a server system 104, as described with reference to FIG. 1. The procedure 1000 is an example procedure 1000 for signing data using a cryptographic key (e.g., an updated private cryptographic key of a cryptographic key pair).

At 1002, a signing procedure is initiated to sign data using a cryptographic key. A computing device and/or a server system load cryptographic libraries, access cryptographic key storage, and set up temporary data structures for the signing operation.

At 1004, a determination is made as to whether a switch timer (e.g., a time period, threshold duration) has expired. The switch timer is a mechanism used to manage the lifecycle of cryptographic keys, ensuring that cryptographic keys are rotated at appropriate intervals to maintain security. The computing device and/or the server system compare a current time against the predefined expiration time of the switch timer, which may be set based on security policies or criterion for cryptographic key management.

At 1006, if the switch timer has expired (e.g., “Y”), then the data is signed using an updated private cryptographic key of the device sending the data. The computing device and/or the server system use the newly generated or updated private cryptographic key for the signing process. The computing device and/or the server system retrieve the updated private cryptographic key from secure storage, verify an integrity and validity of the updated private cryptographic key, and then use the updated private cryptographic key to create a digital signature for the data.

At 1008, if the switch timer has not expired (e.g., “N”), then the data is signed using a current (e.g., original) private cryptographic key. The computing device and/or the server system retrieve the current private cryptographic key from secure storage, perform integrity checks, and apply the private cryptographic key to create a digital signature.

At 1010, the signing is complete. The computing device and/or the server system clear any temporary data used during the signing process and prepare the signed data for transmission or storage.

FIG. 11 depicts a procedure 1100 in an example implementation of automatically updating cryptographic keys using a learning model. The procedure 1100 may be implemented by, or may implement, aspects of FIGS. 1 through 10. For example, the procedure 1100 may be implemented by a computing device and/or a server system, which may be examples of a computing device 102 and a server system 104, as described with reference to FIG. 1. The procedure 1100 is an example procedure 1100 for decrypting data using a cryptographic key (e.g., an updated private cryptographic key of a cryptographic key pair).

At 1102, a decryption procedure is initiated to decrypt data using a cryptographic key. A computing device and/or a server system load cryptographic libraries, access cryptographic key storage, and set up temporary data structures for the decryption operation.

At 1104, a determination is made as to whether a switch timer has expired. The switch timer is a mechanism used to manage the lifecycle of cryptographic keys, ensuring that cryptographic keys are rotated at appropriate intervals to maintain security. The computing device and/or the server system compare a current time against the predefined expiration time of the switch timer, which may be set based on security policies or criterion for cryptographic key management.

At 1106, if the switch timer has not expired (e.g., “N”), then the data is decrypted using an updated private cryptographic key of the device receiving the data. The computing device and/or the server system use the newly generated or updated private cryptographic key for the decryption process. The computing device and/or the server system retrieve the updated private cryptographic key from secure storage, verify an integrity and validity of the updated private cryptographic key, and then use the updated private cryptographic key to decrypt the data.

At 1108, if the switch timer has expired (e.g., “Y”), then the data is decrypted using a current (e.g., original) private cryptographic key. The computing device and/or the server system retrieve the current private cryptographic key from secure storage, perform integrity checks, and apply the private cryptographic key to decrypt the data.

At 1110, the computing device and/or the server system determine whether the decryption was successful. If the decryption failed (e.g., “Y”), then the process may return to step 1108 to attempt decryption with the current private cryptographic key.

At 1112, the decryption is complete. The computing device and/or the server system clear any temporary data used during the decryption process and prepare the decrypted data for further processing or storage.

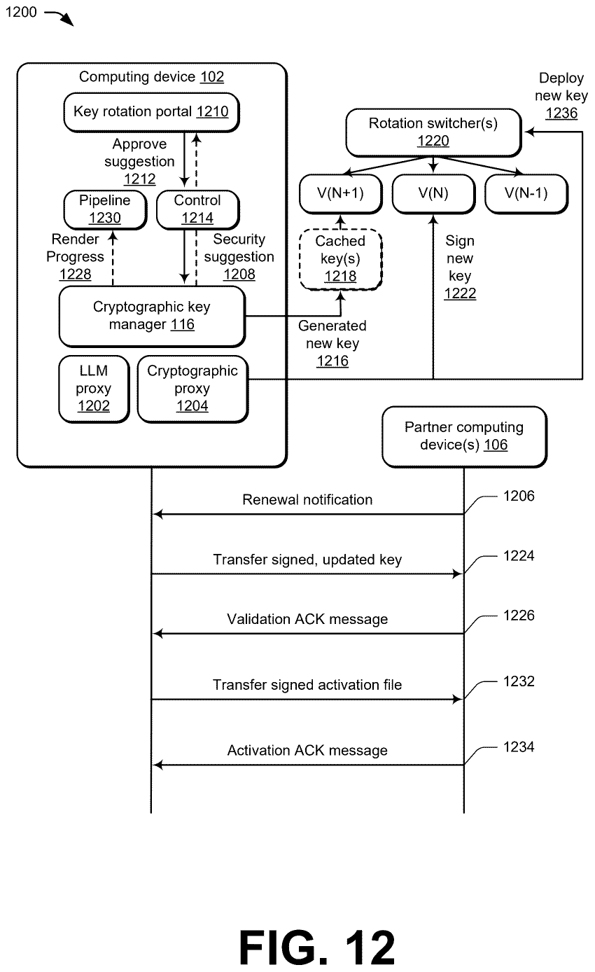

FIG. 12 depicts a procedure 1200 in an example implementation of automatically updating cryptographic keys using a learning model. The procedure 1200 may be implemented by, or may implement, aspects of FIGS. 1 through 11. For example, the procedure 1200 may be implemented by a computing device 102 and/or a server system and a partner computing device 106, which may be examples of a computing device 102, a server system 104, and a partner computing device 106, as described with reference to FIG. 1.

The procedure 1200 may be implemented at least partially by a cryptographic key manager 116. The cryptographic key manager 116 may include or may implement an LLM proxy 1202 and a cryptographic proxy 1204. The LLM proxy 1202 may refer to a component that interfaces with a learning model (e.g., an LLM) to process and interpret natural language inputs related to cryptographic key management. For example, the LLM proxy 1202 may analyze security policies or criterion expressed in human-readable format and/or computer-readable format. The cryptographic proxy 1204 may serve as an intermediary for cryptographic operations, managing the interaction between various system components and the underlying cryptographic infrastructure (e.g., a PKI).

At 1206, a partner computing device 106, such as a server device of a financial institution, transmits a renewal notification to the cryptographic key manager 116. The notification may include information that indicates an expiration of a current cryptographic key and/or a current cryptographic key pair. Additionally, or alternatively, the notification may include a request to update one or more cryptographic keys based on new security criterion, such as transitioning from a first security criterion to a second security criterion for improved security.

Upon receiving the renewal notification, the cryptographic key manager 116 leverages an integrated learning model to generate a security suggestion 1208 based on the renewal notification. The security suggestion 1208 may include recommended parameters for one or more new cryptographic keys, tailored to the criterion defined by the partner computing device 106 (e.g., in the renewal notification at 1206). The computing device 102 outputs (e.g., displays, presents) the security suggestion 1208 via a key rotation portal 1210, which may be a user interface for managing a cryptographic key renewal process. For example, the key rotation portal 1210 may display a comparison of current (e.g., initial, original) cryptographic key attributes and the suggested new cryptographic key attributes, as well as explanations for each recommendation.

The key rotation portal 1210 includes a control component 1214 that receives an approve suggestion message 1212 via the key rotation portal 1210. The approve suggestion message 1212 may be triggered by user input or may be automatic (e.g., without user input) in response to the security suggestion 1208. Once approved, the cryptographic key manager 116 initiates the process to generate one or more new or updated cryptographic keys. The updated cryptographic keys may include an updated cryptographic key pair, including an updated private cryptographic key for signing and/or decryption at a computing device 102, an updated public cryptographic key for encryption of data from the partner computing device 106 to the computing device 102 and/or verification of data from the computing device 102 to the partner computing device 106. The partner computing device may generate an updated cryptographic key pair, including an updated public cryptographic key (e.g., for encryption of data from the computing device 102 to the partner computing device 106 and/or verification of data from the partner computing device 106 to the computing device 102) and an updated private cryptographic key (e.g., for signing and/or decryption at the partner computing device 106).

A public cryptographic key of a counterpart device used for encryption and a private cryptographic key of a device used for signing may be referred to as an outbound cryptographic key pair. A private cryptographic key of a device used for decryption and a public cryptographic key of a counterpart device used for verifying may be referred to as an inbound pair. The computing device 102 and/or the partner computing device 106 may generate respective updated public and private cryptographic keys for implementation at the devices. The cryptographic key manager 116 sends the generated new cryptographic keys 1216 for caching at a data storage (e.g., a local data storage of the computing device 102 and/or a remote data storage at a server system or other remote database).

The cached keys 1218 are accessed by one or more rotation switchers 1220 during the renewal process. The rotation switchers 1220 manage multiple versions of cryptographic keys labeled as V(N+1), V(N), and V(N−1). For example, if the current active cryptographic key is V(N−1), then the rotation switchers 1220 manages one or more new cryptographic keys, including V(N) and V(N+1), in addition to the current active cryptographic key V(N-1). This versioning system provides for smooth transitions between cryptographic key versions and provides rollback capabilities if errors arise with a new cryptographic key. The rotation switchers 1220 may implement a time period during which multiple cryptographic keys are valid, as described with reference to FIG. 9, which provides for a gradual transition to a new cryptographic key without service interruption.

At 1222, the cryptographic proxy 1204 implemented by the cryptographic key manager 116 performs signing of the new cryptographic keys, preparing the new cryptographic keys for distribution and use. Signing the new cryptographic keys may include using a root certificate authority to sign a new public cryptographic key of a public and private cryptographic key pair, thereby creating a chain of trust.

At 1224, the computing device 102 may transmit the signed, updated cryptographic key to the partner computing device 106 (e.g., at least one of a new public cryptographic key implemented by the computing device 102 and/or a new public cryptographic key to be implemented by the partner computing device 106). At 1226, the computing device 102 may receive a validation ACK message from the partner computing device 106. After receiving the validation ACK message, the cryptographic key manager 116 may determine (e.g., understand) that the validation ACK message confirms that the partner computing device 106 has successfully validated the new cryptographic key. The validation process may include verifying the digital signature on the cryptographic key, checking that the cryptographic key satisfies (e.g., meets) the criterion, and determining the cryptographic key is from an expected source (e.g., the computing device 102).

At 1228, the cryptographic key manager 116 sends a render progress message 1228 to a pipeline 1230. For example, throughout a key renewal (e.g., key generation) process, a pipeline 1230 manages the progress of the cryptographic key renewal process, providing comprehensive visual feedback on the status of the cryptographic key renewal process. The visual feedback may include, but is not limited to, a progress bar showing each stage of the renewal process, real-time logs of actions taken, and estimated time to completion. The pipeline 1230 may also integrate with one or more monitoring and alerting systems implemented by the computing device 102. The computing device 102 may send notifications at different stages of the cryptographic key renewal process or if any issues arise during the cryptographic key renewal process. The computing device 102 may output the information through updates to the key rotation portal 1210.

After the validation ACK message is received, the cryptographic proxy 1204 may sign the new cryptographic key ID. At 1232, the computing device 102 transmits a signed activation file to the partner computing device 106, indicating for the partner computing device 106 to activate the new cryptographic keys. The signed activation file may include, but is not limited to, metadata (e.g., an activation timestamp, key IDs) and one or more configuration parameters for deployment of the cryptographic keys.

At 1234, the computing device 102 receives an activation ACK message from the partner computing device 106. After receiving the activation ACK message, the cryptographic key manager 116 may determine (e.g., understand) that the ACK message confirms that the partner computing device 106 has successfully activated the new cryptographic keys. The cryptographic key manager 116 may send a render progress message 1228 to the pipeline 1230 that indicates the partner computing device 106 has successfully activated the new cryptographic keys.

At 1236, the cryptographic key manager 116 deploys the new cryptographic keys using the rotation switchers 1220. Deploying the new cryptographic keys may include making the new cryptographic keys active for use in cryptographic operations. The deployment may include updating relevant systems and services to use the new cryptographic keys, such as web servers, email systems, and gateways. The computing device 102 may implement a phased implementation of the new cryptographic keys, including gradually increasing the usage of the new cryptographic keys while monitoring for any errors or issues related to the implementation of the new cryptographic keys.

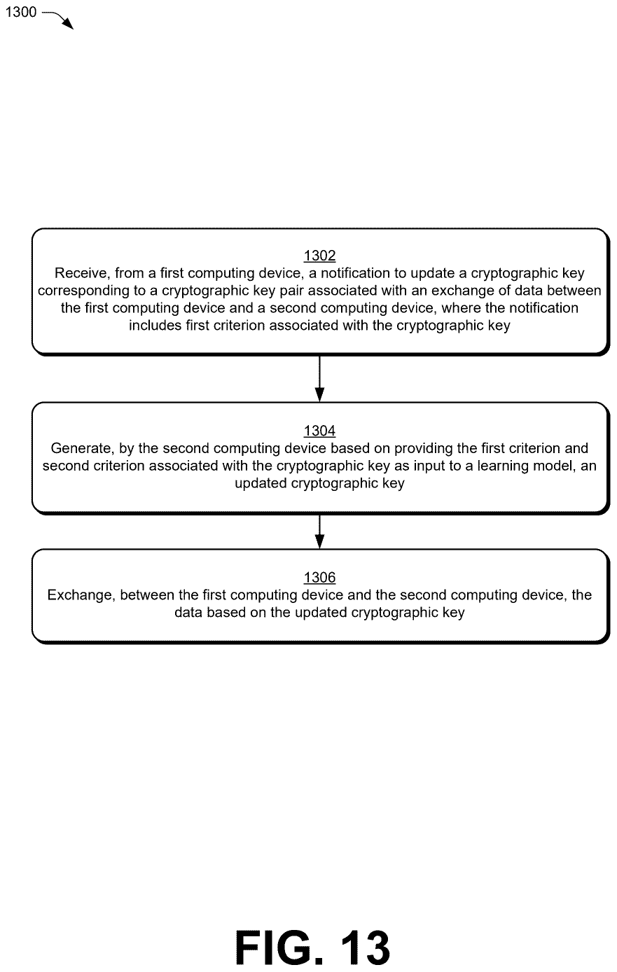

FIG. 13 depicts a procedure 1300 in an example implementation of automatically updating cryptographic keys using a learning model. The procedure 1300 may be implemented by, or may implement, aspects of FIGS. 1 through 12. For example, the procedure 1300 may be implemented by a computing device and/or a server system, which may be examples of a computing device 102 and a server system 104, as described with reference to FIG. 1.

At 1302, a computing device receives a notification from a partner computing device to update a cryptographic key of a cryptographic key pair used to securely exchange data between the computing device and the partner computing device. The notification includes first criterion for the cryptographic key. For example, the first criterion may include one or more of a length of the cryptographic key, an algorithm used for the cryptographic key, a validity period of the cryptographic key, or a format of the cryptographic key.

At 1304, the computing device generates an updated cryptographic key by providing the first criterion and second criterion for the cryptographic key as input to a learning model. The updated cryptographic key satisfies both the first criterion and the second criterion. In some cases, the computing device obtains input that indicates the second criterion, where the first criterion is independent of (e.g., different from, does not rely on) the second criterion. The computing device may store the second criterion at a local data storage of the second computing device, where the computing device accesses the local data storage for generating the updated cryptographic key. The second criterion may include one or more of a length of the cryptographic key, an algorithm used for the cryptographic key, a validity period of the cryptographic key, a use associated with the cryptographic key, or a format of the cryptographic key.

At 1306, the computing device and the partner computing device exchange data using the updated cryptographic key. This exchange may include encrypting (e.g., encoding) the data at the computing device using a public cryptographic key of the cryptographic key pair, signing the data using the a private cryptographic key, which may also be an updated cryptographic key, and transmitting the encrypted or signed data to the partner computing device. Additionally, or alternatively, the exchange of data may include the computing device receiving data that is encrypted and signed using at least one of the cryptographic key or the updated cryptographic key (e.g., from the partner computing device or from another computing device), and then decrypting (e.g., decoding) or verifying the data using a private cryptographic key of the computing device. The computing device verifies the data using the updated cryptographic key (e.g., or the cryptographic key), which may include a public cryptographic key of the partner computing device.

In some examples, for PGP cryptographic key techniques, one or more computing devices (e.g., the computing device and the partner computing device) may each implement a cryptographic key pair. For example, the computing device may implement (e.g., store, use, deploy) a first cryptographic key pair and the partner computing device may implement a second cryptographic key pair. In some examples, to send data, a computing device and/or a partner computing device may encrypt data using a public cryptographic key of the other device (e.g., a counterpart public cryptographic key), The computing device and/or the partner computing device may sign the data using a private cryptographic key of the computing device and/or the partner computing device, respectively.

Additionally, or alternatively, to receive data, a computing device and/or the partner computing device may decrypt the encrypted and signed data using a private cryptographic key of the computing device and/or the partner computing device, respectively. The computing device and/or the partner computing device may verify the data using a public cryptographic key of the other device (e.g., a counterpart public cryptographic key). Thus, to exchange data, a computing device or the partner computing device uses a public cryptographic key of the other of the computing device or the partner computing device to encrypt data (e.g., for outbound data) and to perform signature verification (e.g., for inbound data). The computing device or the partner computing device uses a private cryptographic key of the computing device or the partner computing device, respectively, to decrypt data (e.g., for inbound data after signature verification) and signing (e.g., for outbound data after encryption).

In some examples, the computing devices obtains metadata as output from the learning model. The metadata may be metadata for the updated cryptographic key (e.g., (e.g., an activation timestamp, key IDs, and/or one or more configuration parameters for deployment of the cryptographic key). The computing device outputs the metadata and optionally a suggestion or reason for generating the cryptographic key for display at a user interface of the computing device. The computing device receives feedback via the user interface that indicates at least one of acceptance or rejection of the metadata and/or the suggestion. In some examples, the computing devices generates the updated cryptographic key if the feedback accepts the metadata and/or the suggestion. In some other examples, the computing devices refrains from generating (e.g., cancels, does not generate) the updated cryptographic key if the feedback rejects the metadata and/or the suggestion.

The computing device can transmit the updated cryptographic key to the partner computing device and can receive one or more ACK messages from the partner computing device. The exchange of data can be in response to the ACK messages.

The computing device can select at least one of the updated cryptographic key or another cryptographic key to use for one or more of encrypting, signing, or decrypting the data for a time period after generating the updated cryptographic key. The selection process provides for a smooth transition between cryptographic keys and ensures continuous secure communication during the key update process.

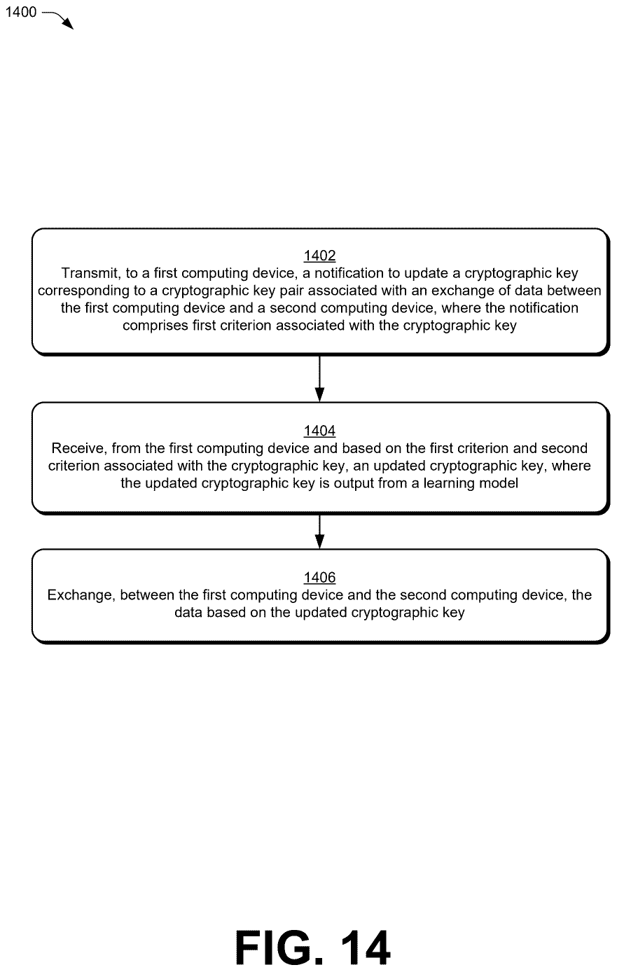

FIG. 14 depicts a procedure 1400 in an example implementation of automatically updating cryptographic keys using a learning model. The procedure 1400 may be implemented by, or may implement, aspects of FIGS. 1 through 13. For example, the procedure 1400 may be implemented by a partner computing device or a partner server device, which may be examples of a partner computing device 106, as described with reference to FIG. 1.

At 1402, a partner computing device (e.g., a second computing device) transmits a notification to a computing device (e.g., a first computing device) that indicates for the computing device to update a cryptographic key of a cryptographic key pair used to secure an exchange of data between the computing device and the partner computing device. The notification includes first criterion for the cryptographic key. The first criterion may include one or more of a length associated with the cryptographic key, an algorithm associated with the cryptographic key, a validity period associated with the cryptographic key, or a format associated with the cryptographic key.

At 1404, the partner computing device receives an updated cryptographic key from the computing device based on the first criterion and second criterion for the cryptographic key. The updated cryptographic key may satisfy the first criterion and the second criterion. In some examples, the updated cryptographic key is output from a learning model. In some cases, the partner computing device obtains input that indicates the second criterion, where the first criterion is independent of the second criterion. The second criterion may be stored at a local data storage of the partner computing device, where the second criterion is accessible for generating the updated cryptographic key. The second criterion may include one or more of a length associated with the cryptographic key, an algorithm associated with the cryptographic key, a validity period associated with the cryptographic key, a use associated with the cryptographic key, or a format associated with the cryptographic key.

At 1406, the partner computing device and the computing device exchange data using the updated cryptographic key. This exchange may include encrypting (e.g., encoding) the data at the partner computing device using a public cryptographic key of the cryptographic key pair, signing the data using a private cryptographic key (e.g., which may also be an updated cryptographic key generated by the partner computing device), and transmitting the encrypted and signed data to the computing device. Additionally, or alternatively, the exchange of data may include the partner computing device receiving data that is encrypted or signed using at least one of the cryptographic key or the updated cryptographic key (e.g., from the computing device or from another computing device), and then decrypting (e.g., decoding) and verifying the data using a private cryptographic key of the partner computing device and the updated cryptographic key (e.g., or the cryptographic key), which includes a public cryptographic key of the computing device.

The partner computing device can transmit one or more ACK messages to the computing device. The exchange of data can be in response to the ACK messages. The partner computing device can select at least one of the updated cryptographic key or another cryptographic key to use for one or more of encrypting, signing, or decrypting the data for a time period after generating the updated cryptographic key. The selection process provides for a smooth transition between cryptographic keys and ensures continuous secure communication during the key update process.

Having described examples of procedures in accordance with one or more implementations, consider now an example of a system and device that can be utilized to implement the various techniques described herein.

### Example System and Device

FIG. 15 illustrates an example of a system generally at 1500 that includes an example of a computing device 1502 that is representative of one or more computing systems and/or devices that may implement the various techniques described herein. This is illustrated through inclusion of the application 110, the cryptographic key manager 116, and the server system 104. The computing device 1502 may be, for example, a server of a service provider, a device associated with a client (e.g., a client device), an on-chip system, and/or any other suitable computing device or computing system.

The example computing device 1502 as illustrated includes a processing system 1504, one or more computer-readable media 1506, and one or more I/O interfaces 1508 that are communicatively coupled, one to another. Although not shown, the computing device 1502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1504 is representative of functionality to perform one or more operations using hardware. Accordingly, the processing system 1504 is illustrated as including hardware elements 1510 that may be configured as processors, functional blocks, and so forth. This may include implementation in hardware as an application specific integrated circuit or other logic device formed using one or more semiconductors. The hardware elements 1510 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 1506 is illustrated as including memory/storage 1512. The memory/storage 1512 represents memory/storage capacity associated with one or more computer-readable media. The memory/storage 1512 may include volatile media (such as random-access memory (RAM)) and/or nonvolatile media (such as read only memory (ROM), Flash memory, optical disks, magnetic disks, and so forth). The memory/storage 1512 may include fixed media (e.g., RAM, ROM, a fixed hard drive, and so on) as well as removable media (e.g., Flash memory, a removable hard drive, an optical disc, and so forth). The computer-readable media 1506 may be configured in a variety of other ways as further described below.

Input/output interface(s) 1508 are representative of functionality to allow a user to enter commands and information to computing device 1502 and also allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1502. By way of example, and not limitation, computer-readable media may include “computer-readable storage media” and “computer-readable signal media.” “Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1510 and computer-readable media 1506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1510. The computing device 1502 may be configured to implement particular instructions and/or functions corresponding to the software and/or hardware modules. Accordingly, implementation of a module that is executable by the computing device 1502 as software may be achieved at least partially in hardware, e.g., through use of computer-readable storage media and/or hardware elements 1510 of the processing system 1504. The instructions and/or functions may be executable/operable by one or more articles of manufacture (for example, one or more computing devices 1502 and/or processing systems 1504) to implement techniques, modules, and examples described herein.

The techniques described herein may be supported by various configurations of the computing device 1502 and are not limited to the specific examples of the techniques described herein. This functionality may also be implemented all or in part through use of a distributed system, such as over a “cloud” 1514 via a platform 1516 as described below.

The cloud 1514 includes and/or is representative of a platform 1516 for resources 1518. The platform 1516 abstracts underlying functionality of hardware (e.g., servers) and software resources of the cloud 1514. The resources 1518 may include applications and/or data that can be utilized while computer processing is executed on servers that are remote from the computing device 1502. Resources 1518 can also include services provided over the Internet and/or through a subscriber network, such as a cellular or Wi-Fi network.

The platform 1516 may abstract resources and functions to connect the computing device 1502 with other computing devices. The platform 1516 may also serve to abstract scaling of resources to provide a corresponding level of scale to encountered demand for the resources 1518 that are implemented via the platform 1516. Accordingly, in an interconnected device embodiment, implementation of functionality described herein may be distributed throughout the system 1500. For example, the functionality may be implemented in part on the computing device 1502 as well as via the platform 1516 that abstracts the functionality of the cloud 1514.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, from a first computing device, a notification to update a cryptographic key corresponding to a cryptographic key pair associated with an exchange of data between the first computing device and a second computing device, wherein the notification comprises first criterion associated with the cryptographic key;
generating, by the second computing device based at least in part on providing the first criterion and second criterion associated with the cryptographic key as input to a learning model, an updated cryptographic key; and
exchanging, between the first computing device and the second computing device, the data based at least in part on the updated cryptographic key.

2. The computer-implemented method of claim 1, further comprising:
obtaining, as output from the learning model, metadata associated with the updated cryptographic key;
outputting the metadata for display at a user interface associated with the second computing device; and
receiving, via the user interface, feedback that indicates at least one of acceptance of the metadata or rejection of the metadata, wherein generating the updated cryptographic key is based at least in part on the acceptance of the metadata or the rejection of the metadata.

3. The computer-implemented method of claim 1, further comprising:
transmitting, to the first computing device, the updated cryptographic key, wherein the updated cryptographic key comprises a public cryptographic key of the cryptographic key pair; and
receiving, from the first computing device, at least one acknowledgement message associated with the updated cryptographic key, wherein exchanging the data is based at least in part on the at least one acknowledgement message.

4. The computer-implemented method of claim 1, further comprising:
selecting, by the second computing device and based at least in part on another cryptographic key corresponding to the cryptographic key pair, at least one of the updated cryptographic key or the cryptographic key to use for one or more of encrypting, signing, or decrypting the data for a time period after generating the updated cryptographic key.

5. The computer-implemented method of claim 1, wherein exchanging the data comprises:
encrypting, at the second computing device, the data using a public cryptographic key associated with the first computing device;
signing, at the second computing device, the data using a private cryptographic key of the cryptographic key pair, wherein the updated cryptographic key comprises the private cryptographic key; and
transmitting the data to the first computing device.

6. The computer-implemented method of claim 1, wherein exchanging the data comprises:
receiving, at the second computing device, the data, wherein the data is encrypted based at least in part on a public cryptographic key of the cryptographic key pair, wherein the public cryptographic key comprises the cryptographic key or the updated cryptographic key;
decrypting the data using a private cryptographic key associated with the second computing device; and
verifying, at the second computing device, the data using a public cryptographic key associated with the first computing device.

7. The computer-implemented method of claim 1, wherein the first criterion and the second criterion comprises one or more of a length associated with the cryptographic key, an algorithm associated with the cryptographic key, a validity period associated with the cryptographic key, a use associated with the cryptographic key, or a format associated with the cryptographic key.

8. The computer-implemented method of claim 1, wherein the updated cryptographic key satisfies the first criterion and satisfies the second criterion.

9. The computer-implemented method of claim 1, further comprising:
obtaining, at the second computing device, input that indicates the second criterion, wherein the first criterion is independent of the second criterion; and
storing the second criterion at a local data storage of the second computing device, wherein the second criterion is accessible for generating the updated cryptographic key.

10. A system comprising:
one or more processors; and
a computer-readable storage medium storing instructions that are executable by the one or more processors to perform operations comprising:
receiving, from a first computing device, a notification to update a cryptographic key corresponding to a cryptographic key pair associated with an exchange of data between the first computing device and a second computing device, wherein the notification comprises first criterion associated with the cryptographic key;
generating, by the second computing device based at least in part on providing the first criterion and second criterion associated with the cryptographic key as input to a learning model, an updated cryptographic key; and
exchanging, between the first computing device and the second computing device, the data based at least in part on the updated cryptographic key.

11. The system of claim 10, wherein the operations further comprise:
obtaining, as output from the learning model, metadata associated with the updated cryptographic key;
outputting the metadata for display at a user interface associated with the second computing device; and
receiving, via the user interface, feedback that indicates at least one of acceptance of the metadata or rejection of the metadata, wherein generating the updated cryptographic key is based at least in part on the acceptance of the metadata or the rejection of the metadata.

12. The system of claim 10, wherein the operations further comprise:
transmitting, to the first computing device, the updated cryptographic key, wherein the updated cryptographic key comprises a public cryptographic key of the cryptographic key pair; and
receiving, from the first computing device, at least one acknowledgement message associated with the updated cryptographic key, wherein exchanging the data is based at least in part on the at least one acknowledgement message.

13. The system of claim 10, wherein the operations further comprise:
selecting, by the second computing device and based at least in part on another cryptographic key corresponding to the cryptographic key pair, at least one of the updated cryptographic key or the cryptographic key to use for at least one of signing, encrypting, or decrypting the data for a time period after generating the updated cryptographic key.

14. A computer-implemented method comprising:
transmitting, to a first computing device, a notification to update a cryptographic key corresponding to a cryptographic key pair associated with an exchange of data between the first computing device and a second computing device, wherein the notification comprises first criterion associated with the cryptographic key;
receiving, from the first computing device and based at least in part on the first criterion and second criterion associated with the cryptographic key, an updated cryptographic key, wherein the updated cryptographic key is output from a learning model; and
exchanging, between the first computing device and the second computing device, the data based at least in part on the updated cryptographic key.

15. The computer-implemented method of claim 14, further comprising:
transmitting, to the first computing device, at least one acknowledgement message associated with the updated cryptographic key, wherein exchanging the data is based at least in part on the at least one acknowledgement message.

16. The computer-implemented method of claim 14, further comprising:
selecting, by the second computing device and based at least in part on another cryptographic key corresponding to the cryptographic key pair, at least one of the updated cryptographic key or the cryptographic key to use for one or more of encrypting, signing, or decrypting the data for a time period after generating the updated cryptographic key.

17. The computer-implemented method of claim 14, wherein exchanging the data comprises:
encrypting, at the second computing device, the data using a public cryptographic key of the cryptographic key pair, wherein the updated cryptographic key comprises the public cryptographic key;
signing, at the second computing device, a private cryptographic key associated with the second computing device; and
transmitting the data to the first computing device.

18. The computer-implemented method of claim 14, wherein exchanging the data comprises:
receiving, at the second computing device, the data, wherein the data is encrypted based at least in part on a public cryptographic key associated with the second computing device;
decrypting the data using a private cryptographic key associated with the second computing device; and
verifying, at the second computing device, the data using a public cryptographic key associated with the first computing device, wherein the updated cryptographic key comprises the public cryptographic key associated with the first computing device.

19. The computer-implemented method of claim 14, wherein the first criterion and the second criterion comprises one or more of a length associated with the cryptographic key, an algorithm associated with the cryptographic key, a validity period associated with the cryptographic key, a use associated with the cryptographic key, or a format associated with the cryptographic key, and wherein the updated cryptographic key satisfies the first criterion and satisfies the second criterion.

20. The computer-implemented method of claim 14, further comprising:
obtaining, at the second computing device, input that indicates the second criterion, wherein the first criterion is independent of the second criterion; and
storing the second criterion at a local data storage of the second computing device, wherein the second criterion is accessible for generating the updated cryptographic key.
